(19) United States
(12) Patent Application Publication
(10) Pub. No.: US 2008/0261113 A1
(43) Pub. Date: Oct. 23, 2008

(54) SECONDARY ELECTROCHEMICAL CELL WITH HIGH RATE CAPABILITY

(76) Inventors: Haitao Huang, Henderson, NV (US); M. Yazid Saidi, Henderson, NV (US); Jeremy Barker, Oxfordshire (GB)

Correspondence Address: VALENCE TECHNOLOGY, INC., 1889 E. MAULE AVENUE, SUITE A, LAS VEGAS, NV, 89119, US

(21) Appl. No.: 11/939,837

(22) Filed: Nov. 14, 2007

Related U.S. Application Data
(60) Provisional application No. 60/865,987, filed on Nov. 15, 2006.

(51) Int. Cl. H01M 4/00

(52) U.S. Cl. 429/221

(57) ABSTRACT

The invention provides an electrochemical cell which includes a first electrode having a electrode active material, a second electrode which is a counter electrode to the first electrode, and an electrolyte. The negative electrode active material is represented by the general formula E_{f}Ti_{g}DₕOᵢ.

This Application claims the benefit of Provisional Application Ser. No. 60/865,987 filed Nov. 15, 2006.

### FIELD OF THE INVENTION

This invention relates to an electrochemical cell, and more particularly to a secondary electrochemical cell employing a polyanion-based active material in a first electrode, and a titanium-oxide-based material in a second counter-electrode.

### BACKGROUND OF THE INVENTION

A battery pack consists of one or more electrochemical cells or batteries, wherein each cell typically includes a positive electrode, a negative electrode, and an electrolyte or other material for facilitating movement of ionic charge carriers between the negative electrode and positive electrode. As the cell is charged, cations migrate from the positive electrode to the electrolyte and, concurrently, from the electrolyte to the negative electrode. During discharge, cations migrate from the negative electrode to the electrolyte and, concurrently, from the electrolyte to the positive electrode.

### SUMMARY OF THE INVENTION

The present invention provides a novel secondary electrochemical cell employing a first electrode active material represented by the general formula:

AₐM_{b}L_{c}Z_{d},

wherein:
(i) A is selected from the group consisting of elements from Group I of the Periodic Table, and mixtures thereof, and 0≦a≦9;
(ii) M includes at least one redox active element, and 0<b≦4;
(iii) L is selected from the group consisting of X′[O₄₋ₓ,Y′ₓ], X′[O_{4-y},Y′_{2y}], X″S₄, [X_{z}′″,X′_{1-z}]O₄, and mixtures thereof, wherein:
   (a) X′ and X′″ are each independently selected from the group consisting of P, As, Sb, Si, Ge, V, S, and mixtures thereof;
   (b) X″ is selected from the group consisting of P, As, Sb, Si, Ge, V, and mixtures thereof;
   (c) Y′ is selected from the group consisting of halogens selected from Group 17 of the Periodic Table, S, N, and mixtures thereof;
   (d) 0≦x≦3, 0≦y≦2, 0≦z≦1 and 0<z≦3; and
(iv) Z is selected from the group consisting of a hydroxyl (OH), a halogen selected from Group 17 of the Periodic Table, and mixtures thereof, and 0≦e≦4;

wherein A, M, L, Z, a, b, c and d are selected so as to maintain electroneutrality of the first electrode active material in its nascent state.

The secondary electrochemical cell includes an electrode assembly enclosed in a casing. The electrode assembly includes a separator interposed between a first electrode (positive electrode) and a counter second electrode (negative electrode), for electrically insulating the first electrode from the second electrode. An electrolyte (preferably a non-aqueous electrolyte) is provided for transferring ionic charge carriers between the first electrode and the second electrode during charge and discharge of the electrochemical cell.

The first and second electrodes each include an electrically conductive current collector for providing electrical communication between the electrodes and an external load. An electrode film is formed on at least one side of each current collector, preferably both sides of the positive electrode current collector.

A first electrode plate contacts an exposed portion of the first electrode current collector in order to provide electrical communication between the first electrode current collector and an external load. An opposing second electrode plate contacts an exposed portion of the second electrode current collector in order to provide electrical communication between the second electrode current collector and an external load.

The counter-second electrode employs a counter-electrode active material represented by the general formula:

E_{f}Ti_{g}DₕOᵢ,

wherein:
(i) E is selected from the group consisting of elements from Group I of the Periodic Table, and mixtures thereof, and 0<f<12;
   (ii) 0≦g≦6;
   (iii) D is selected from the group consisting of Al, Zr, Mg, Ca, Zn, Cd, Fe, Mn, Ni, Co, and mixtures thereof, and 0≦h≦2; and
   (iv) 2≦i≦12.

wherein E, D, f, g, h and i are selected so as to maintain electroneutrality of the second counter-electrode active material in its nascent state.

### BRIEF DESCRIPTION OF THE DRAWINGS

FIG. 1 is a schematic cross-sectional diagram illustrating the structure of a non-aqueous electrolyte cylindrical electrochemical cell of the present invention.

FIG. 2 is a plot of cathode specific capacity vs. cell voltage for a Li/1M LiPF₆ (EC/DMC)/Li₄Ti₅O₁₂ cell.

FIG. 3 is a plot of cathode specific capacity vs. cell voltage for a Li/1M LiPF₆ (EC/DMC)/Li₂Ti₃O₇ cell.

FIG. 4 shows the first cycle EVS results for a LiVPO₄F/1M LiPF₆ (EC/DMC)/Li₂Ti₃O₇ cell.

FIG. 5 is an EVS differential capacity plot based on FIG. 4.

FIG. 6 is a plot of cathode specific capacity vs. cycle number for LiVPO₄F/1M LiPF₆ (EC/DMC)/Li₄Ti₅O₁₂ cells.

FIG. 7 shows the first cycle EVS results for a LiVPO₄F/1M LiPF₆ (EC/DMC)/Li₄Ti₅O₁₂ cell.

FIG. 8 is an EVS differential capacity plot based on FIG. 7.

FIG. 9 shows the voltage profile plot for the first cycle EVS response of a Na₃V₂(PO₄)₂F₃/1M LiPF₆ (EC/DMC)/Li₄Ti₅O₁₂ cell.

FIG. 10 shows the differential capacity plot for the first cycle EVS response of a Na₃V₂(PO₄)₂F₃/1M LiPF₆ (EC/DMC)/Li₄Ti₅O₁₂ cell.

FIG. 11 shows the voltage profile plot for the fifth cycle EVS response of a Na₃V₂(PO₄)₂F₃/1M LiPF₆ (EC/DMC)/Li₄Ti₅O₁₂ cell.

FIG. 12 shows the differential capacity plot for the fifth cycle EVS response of a Na₃V₂(PO₄)₂F₃/1M LiPF₆ (EC/DMC)/Li₄Ti₅O₁₂ cell.

FIG. 13 shows the cycling behavior of the Na₃V₂(PO₄)₂F₃/1M LiPF₆ (EC/DMC)/Li₄Ti₅O₁₂ cell.

FIG. 14 shows the voltage profile plot for the first cycle EVS response of a Na₃V₂(PO₄)₂F₃/1M LiPF₆+2M NaPF₆ (EC/DMC)/Li₄Ti₅O₁₂ cell.

FIG. 15 shows the differential capacity plot for the first cycle EVS response of a Na₃V₂(PO₄)₂F₃/1M LiPF₆+2M NaPF₆ (EC/DMC)/Li₄Ti₅O₁₂ cell.

FIG. 16 shows the voltage profile plot for the first cycle EVS response of a Na₃V₂(PO₄)₂F₃/1M LiPF₆+2M NaPF₆ (EC/DMC)/Li₄Ti₅O₁₂ cell.

FIG. 17 shows the differential capacity plot for the first cycle EVS response of a Na₃V₂(PO₄)₂F₃/1M LiPF₆+2M NaPF₆ (EC/DMC)/Li₄Ti₅O₁₂ cell.

FIG. 18 shows the cycling behavior of a first L₃V₂(PO₄)₃/0.13M LiPF₆ (EC/DMC/EMC)/Li₄Ti₅O₁₂ cell.

FIG. 19 shows the cycling behavior of a second L₃V₂(PO₄)₃/0.13M LiPF₆ (EC/DMC/EMC)/Li₄Ti₅O₁₂ cell.

### DETAILED DESCRIPTION OF THE PREFERRED EMBODIMENTS

It has been found that the novel electrochemical cells of this invention afford benefits over such materials and devices among those known in the art. Such benefits include, without limitation, one or more of increased capacity, enhanced cycling capability, enhanced reversibility, enhanced ionic conductivity, enhanced electrical conductivity, enhanced rate capability, and reduced costs. Specific benefits and embodiments of the present invention are apparent from the detailed description set forth herein below. It should be understood, however, that the detailed description and specific examples, while indicating embodiments among those preferred, are intended for purposes of illustration only and are not intended to limit the scope of the invention.

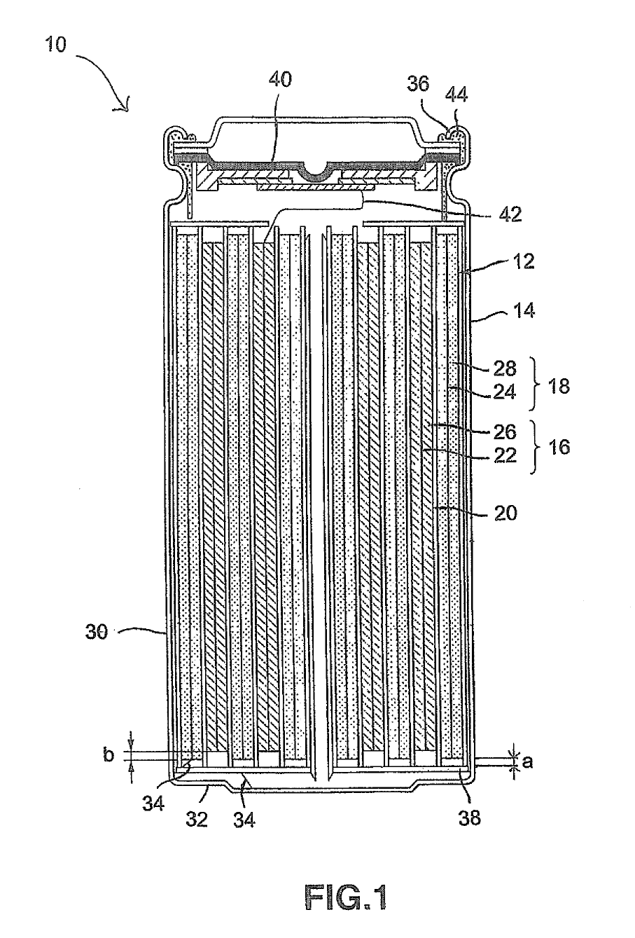

Referring to FIG. 1, one embodiment of a secondary electrochemical cell 10 having a positive electrode active material described herein below as general formula (1), and a negative electrode active material described herein below as general formula (9), is illustrated. The cell 10 includes a spirally coiled or wound electrode assembly 12 enclosed in a sealed container, preferably a rigid cylindrical casing 14. The electrode assembly 12 includes: a positive electrode 16 consisting of, among other things, an electrode active material described herein below; a counter negative electrode 18; and a separator 20 interposed between the first and second electrodes 16,18. The separator 20 is preferably an electrically insulating, ionically conductive microporous film, and composed of a polymeric material selected from the group consisting of polyethylene, polyethylene oxide, polyacrylonitrile and polyvinylidene fluoride, polymethyl methacrylate, polysiloxane, copolymers thereof, and admixtures thereof.

Each electrode 16,18 includes a current collector 22 and 24, respectively, for providing electrical communication between the electrodes 16,18 and an external load. Each current collector 22,24 is a foil or grid of an electrically conductive metal such as iron, copper, aluminum, titanium, nickel, stainless steel, or the like, having a thickness of between 5 μm and 100 μm, preferably 5 μm and 20 μm. In one embodiment, each current collector is a foil or grid of aluminum.

Optionally, the current collector may be treated with an oxide-removing agent such as a mild acid and the like, and coated with an electrically conductive coating for inhibiting the formation of electrically insulating oxides on the surface of the current collector 22,24. Examples of suitable coatings include polymeric materials comprising a homogenously dispersed electrically conductive material (e.g. carbon), such polymeric materials including: acrylics including acrylic acid and methacrylic acids and esters, including poly (ethylene-co-acrylic acid); vinylic materials including poly(vinyl acetate) and poly(vinylidene fluoride-co-hexafluoropropylene); polyesters including poly(adipic acid-co-ethylene glycol); polyurethanes; fluoroelastomers; and mixtures thereof.

The positive electrode 16 further includes a positive electrode film 26 formed on at least one side of the positive electrode current collector 22, preferably both sides of the positive electrode current collector 22, each film 26 having a thickness of between 10 μm and 150 μm, preferably between 25 μm an 125 μm, in order to realize the optimal capacity for the cell 10. The positive electrode film 26 is preferably composed of between 80% and 99% by weight of a positive electrode active materials described herein below by general formula (1), between 1% and 10% by weight binder, and between 1% and 10% by weight electrically conductive agent.

Suitable binders include: polyacrylic acid; carboxymethylcellulose; diacetylcellulose; hydroxypropylcellulose; polyethylene; polypropylene; ethylene-propylene-diene copolymer; polytetrafluoroethylene; polyvinylidene fluoride; styrene-butadiene rubber; tetrafluoroethylene-hexafluoropropylene copolymer; polyvinyl alcohol; polyvinyl chloride; polyvinyl pyrrolidone; tetrafluoroethylene-perfluoroalkylvinyl ether copolymer; vinylidene fluoride-hexafluoropropylene copolymer; vinylidene fluoride-chlorotrifluoroethylene copolymer; ethylenetetrafluoroethylene copolymer; polychlorotrifluoroethylene; vinylidene fluoride-pentafluoropropylene copolymer; propylene-tetrafluoroethylene copolymer; ethylene-chlorotrifluoroethylene copolymer; vinylidene fluoride-hexafluoropropylene-tetrafluoroethylene copolymer; vinylidene fluoride-perfluoromethylvinyl ether-tetrafluoroethylene copolymer; ethylene-acrylic acid copolymer; ethylene-methacrylic acid copolymer; ethylene-methyl acrylate copolymer; ethylene-methyl methacrylate copolymer; styrene-butadiene rubber; fluorinated rubber; polybutadiene; and admixtures thereof. Of these materials, most preferred are polyvinylidene fluoride and polytetrafluoroethylene.

Suitable electrically conductive agents include: natural graphite (e.g. flaky graphite, and the like); manufactured graphite; carbon blacks such as acetylene black, Ketzen black, channel black, furnace black, lamp black, thermal black, and the like; conductive fibers such as carbon fibers and metallic fibers; metal powders such as carbon fluoride, copper, nickel, and the like; and organic conductive materials such as polyphenylene derivatives.

The negative electrode 18 is formed of a negative electrode film 28 formed on at least one side of the negative electrode current collector 24, preferably both sides of the negative electrode current collector 24. The negative electrode film 28 is composed of between 80% and 95% of by weight of a negative electrode active material described herein below by general formula (9), and (optionally) between 1% and 10% by of an weight electrically conductive agent.

Referring again to FIG. 1, to ensure that the electrodes 16,18 do not come into electrical contact with one another, in the event the electrodes 16,18 become offset during the winding operation during manufacture, the separator 20 “overhangs” or extends a width “a” beyond each edge of the negative electrode 18. In one embodiment, 50 μm≦a≦2,000 μm. To ensure alkali metal does not plate on the edges of the negative electrode 18 during charging, the negative electrode 18 “overhangs” or extends a width “b” beyond each edge of the positive electrode 16. In one embodiment, 50 μm≦b≦2,000 μm.

The cylindrical casing 14 includes a cylindrical body member 30 having a closed end 32 in electrical communication with the negative electrode 18 via a negative electrode lead 34, and an open end defined by crimped edge 36. In operation, the cylindrical body member 30, and more particularly the closed end 32, is electrically conductive and provides electrical communication between the negative electrode 18 and an external load (not illustrated). An insulating member 38 is interposed between the spirally coiled or wound electrode assembly 12 and the closed end 32.

A positive terminal subassembly 40 in electrical communication with the positive electrode 16 via a positive electrode lead 42 provides electrical communication between the positive electrode 16 and the external load (not illustrated). Preferably, the positive terminal subassembly 40 is adapted to sever electrical communication between the positive electrode 16 and an external load/charging device in the event of an overcharge condition (e.g. by way of positive temperature coefficient (PTC) element), elevated temperature and/or in the event of excess gas generation within the cylindrical casing 14. Suitable positive terminal assemblies 40 are disclosed in U.S. Pat. No. 6,632,572 to Iwaizono, et al., issued Oct. 14, 2003; and U.S. Pat. No. 6,667,132 to Okochi, et al., issued Dec. 23, 2003. A gasket member 42 sealingly engages the upper portion of the cylindrical body member 30 to the positive terminal subassembly 40.

In one embodiment, a non-aqueous electrolyte (not shown) is provided for transferring ionic charge carriers between the positive electrode 16 and the negative electrode 18 during charge and discharge of the electrochemical cell 10. The electrolyte includes a non-aqueous solvent and an alkali metal salt dissolved therein (most preferably, a lithium salt). In the electrochemical cell's nascent state (namely, before the cell undergoes cycling), the non-aqueous electrolyte contains one or more metal-ion charge carriers other than the element(s) selected from composition variables A and E of general formulas (1) and (9), respectively.

Suitable solvents include: a cyclic carbonate such as ethylene carbonate, propylene carbonate, butylene carbonate or vinylene carbonate; a non-cyclic carbonate such as dimethyl carbonate, diethyl carbonate, ethyl methyl carbonate or dipropyl carbonate; an aliphatic carboxylic acid ester such as methyl formate, methyl acetate, methyl propionate or ethyl propionate; a .gamma.-lactone such as γ-butyrolactone; a non-cyclic ether such as 1,2-dimethoxyethane, 1,2-diethoxyethane or ethoxymethoxyethane; a cyclic ether such as tetrahydrofuran or 2-methyltetrahydrofuran; an organic aprotic solvent such as dimethylsulfoxide, 1,3-dioxolane, formamide, acetamide, dimethylformamide, dioxolane, acetonitrile, propylnitrile, nitromethane, ethyl monoglyme, phospheric acid triester, trimethoxymethane, a dioxolane derivative, sulfolane, methylsulfolane, 1,3-dimethyl-2-imidazolidinone, 3-methyl-2-oxazolidinone a propylene carbonate derivative, a tetrahydrofuran derivative, ethyl ether, 1,3-propanesultone, anisole, dimethylsulfoxide and N-methylpyrrolidone; and mixtures thereof. A mixture of a cyclic carbonate and a non-cyclic carbonate or a mixture of a cyclic carbonate, a non-cyclic carbonate and an aliphatic carboxylic acid ester, are preferred.

Suitable alkali metal salts, particularly alkali-metal salts, include: RClO₄; RBF₄; RPF₆; RAlCl₄; RSbF₆; RSCN; RCF₃SO₃; RCF₃Co₂; R(CF₃SO₂)₂; RAsF₆; RN(CF₃SO2)₂; RB₁₀Cl₁₀; an alkali-metal lower aliphatic carboxylate; RCl; RBr; RI; a chloroboran of an alkali-metal; alkali-metal tetraphenylborate; alkali-metal imides (e.g. alkali metal bis(trifluoromethanesulfonyl)imides); and mixtures thereof, wherein R is selected from the group consisting of alkali-metal from Group I of the Periodic Table. Preferably, the electrolyte contains at least LiPF₆.

In another embodiment, a room-temperature ionic liquid (RTIL) electrolyte (not shown) is provided for transferring ionic charge carriers between the positive electrode 16 and the negative electrode 18 during charge and discharge of the electrochemical cell 10. The RTIL electrolyte contains an alkali metal salt described herein dissolved in an ionic liquid selected from the group consisting of compounds represented by general formulas (A) through (K):

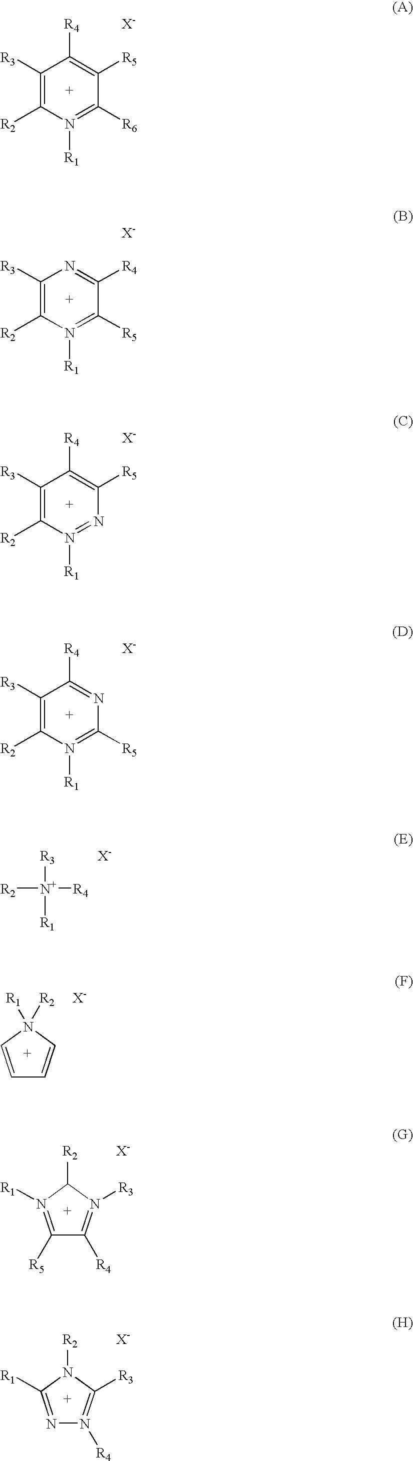

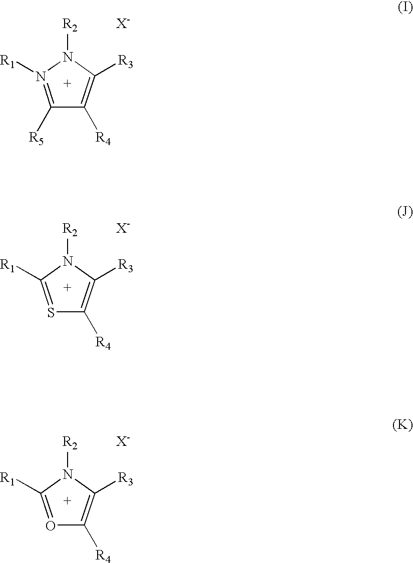

and mixtures thereof, wherein:

(1) R₁, R₂, R₃, R₄, R₅ and R₆ are each independently selected from the group consisting of: H; F; Cl; Br; and linear and branched alkyl, hydroxyalkyl, benzylalkyl, alkyl halide, oxoalkyl, alkoxyalkyl, aminoalkyl, carboxyalkyl, sulfonylalkyl, phosphoalkyl, and sulfoalkyl groups of 1 to 7 carbon atoms; and

(2) X⁻ is selected the group consisting of: Cl⁻; BF₄⁻; Br⁻; (CF₃)ₐPF_{b}⁻ (wherein a+b=6 and a and b are each greater or equal to 0 (a,b≧0); compounds represented by general formulas (L) and (M):

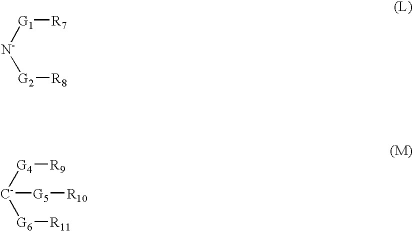

and mixtures thereof; wherein:

(1) G₁ and G₂, G₃, G₄, G₅, and G₆ are each independently selected from the group consisting of —CO— and SO₂—; and

(2) R₇, R₈, R₉, R₁₀, and R₁₁ are each independently selected from the group consisting of H, F, Cl, Br, halogenated alkyl groups of 1 to 5 carbon atoms, and alkyl nitrile groups of 1 to 5 carbon atoms.

RTIL cations useful herein include, without limitation: 1-ethyl-3-methylimidasolium; 1,2-dimethyl-3-propylimidazolium; 1-propyl-2,3-dimethylimidazolium; 1-methyl-3-propylpyrrolidinium; 1-methyl-3-propylpiperidinium; N,N-diethyl-N-methyl-N-(2-methoxyethyl)ammonium; 1-butyl-3-methylimidazolium tetrafluoroborate; 1-butyl-3-methylimidazolium; 1-ethyl-3-methylimidazolium; N-methyl-N-alkyl piperidinium; butyldimethylpropylammonium; and benzyldimethylethylammonium.

RTIL anions useful herein include, without limitation: bis(trifluoromethanesulfonyl)imide; and (perfluoroalkylsulfonyl)imide.

As noted herein above, for all embodiments described herein, the positive electrode film 26 contains a positive electrode active material represented by the general formula (1):

AₐM_{b}L_{c}Z_{d}. (1)

The electrode active materials described herein are in their nascent or as-synthesized state, prior to undergoing cycling in an electrochemical cell. The components of the electrode active material are selected so as to maintain electroneutrality of the electrode active material. The stoichiometric values of one or more elements of the composition may take on non-integer values.

For all embodiments described herein, composition variable A contains at least one element capable of forming a positive ion and undergoing deintercalation from the active material upon charge of an electrochemical cell containing the same. In one embodiment, A is selected from the group consisting of elements from Group I of the Periodic Table, and mixtures thereof (e.g. Aₐ=A_{a-a′}A′_{a′}, wherein A and A′ are each selected from the group consisting of elements from Group I of the Periodic Table and are different from one another, and a′<a). In one subembodiment, in the material's as-synthesized or nascent state, A does not include lithium (Li). In another subembodiment, in the material's as-synthesized or nascent state, A does not include lithium (Li) or sodium (Na).

As referred to herein, “Group” refers to the Group numbers (i.e., columns) of the Periodic Table as defined in the current IUPAC Periodic Table. (See, e.g., U.S. Pat. No. 6,136,472, Barker et al., issued Oct. 24, 2000, incorporated by reference herein). In addition, the recitation of a genus of elements, materials or other components, from which an individual component or mixture of components can be selected, is intended to include all possible sub-generic combinations of the listed components, and mixtures thereof.

Preferably, a sufficient quantity (a) of composition variable A should be present so as to allow all of the “redox active” elements of composition variable M (as defined herein below) to undergo oxidation/reduction. Removal of an amount (a) of composition variable A from the electrode active material is accompanied by a change in oxidation state of at least one of the “redox active” elements in the active material, as defined herein below. The amount of redox active material available for oxidation/reduction in the active material determines the amount (a) of composition variable A that may be removed. Such concepts are, in general application, well known in the art, e.g., as disclosed in U.S. Pat. No. 4,477,541, Fraioli, issued Oct. 16, 1984; and U.S. Pat. No. 6,136,472, Barker, et al., issued Oct. 24, 2000, both of which are incorporated by reference herein.

Referring again to general formula (1), in all embodiments described herein, composition variable M is at least one redox active element. As used herein, the term “redox active element” includes those elements characterized as being capable of undergoing oxidation/reduction to another oxidation state when the electrochemical cell is operating under normal operating conditions. As used herein, the term “normal operating conditions” refers to the intended voltage at which the cell is charged, which, in turn, depends on the materials used to construct the cell.

Redox active elements useful herein with respect to composition variable M include, without limitation, elements from Groups 4 through 11 of the Periodic Table, as well as select non-transition metals, including, without limitation, ti (Titanium), V (Vanadium), Cr (Chromium), Mn (Manganese), Fe (Iron), Co (Cobalt), Ni (Nickel), Cu (Copper), Nb (Niobium), Mo (Molybdenum), Ru (Ruthenium), Rh (Rhodium), Pd (Palladium), Os (Osmium), Ir (Iridium), Pt (Platinum), Au (Gold), Si (Silicon), Sn (Tin), Pb (Lead), and mixtures thereof. For each embodiment described herein, M may comprise a mixture of oxidation states for the selected element (e.g., M=Mn²⁺ Mn⁴⁺). Also, “include,” and its variants, is intended to be non-limiting, such that recitation of items in a list is not to the exclusion of other like items that may also be useful in the materials, compositions, devices, and methods of this invention.

In one embodiment, composition variable M is a redox active element. In one subembodiment, M is a redox active element selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, and Pb²⁺. In another subembodiment, M is a redox active element selected from the group consisting of Ti³⁺, V³⁺, Cr³⁺, Mn³⁺, Fe³⁺, Co³⁺, Ni³⁺, Mo³⁺, and Nb³⁺.

In another embodiment, composition variable M includes one or more redox active elements and (optionally) one or more non-redox active elements. As referred to herein, “non-redox active elements” include elements that are capable of forming stable active materials, and do not undergo oxidation/reduction when the electrode active material is operating under normal operating conditions.

Among the non-redox active elements useful herein include, without limitation, those selected from Group 2 elements, particularly Be (Beryllium), Mg (Magnesium), Ca (Calcium), Sr (Strontium), Ba (Barium); Group 3 elements, particularly Sc (Scandium), Y (Yttrium), and the lanthanides, particularly La (Lanthanum), Ce (Cerium), Pr (Praseodymium), Nd (Neodymium), Sm (Samarium); Group 12 elements, particularly Zn (Zinc) and Cd (Cadmium); Group 13 elements, particularly B (Boron), Al (Aluminum), Ga (Gallium), In (Indium), Tl (Thallium); Group 14 elements, particularly C (Carbon) and Ge (Germanium), Group 15 elements, particularly As (Arsenic), Sb (Antimony), and Bi (Bismuth); Group 16 elements, particularly Te (Tellurium); and mixtures thereof.

In one embodiment, M=MIₙMIIₒ, wherein 0<o+n≦3 and each of o and n is greater than zero (0<o,n), wherein MI and MII are each independently selected from the group consisting of redox active elements and non-redox active elements, wherein at least one of MI and MII is redox active. MI may be partially substituted with MII by isocharge or aliovalent substitution, in equal or unequal stoichiometric amounts.

“Isocharge substitution” refers to a substitution of one element on a given crystallographic site with an element having the same oxidation state (e.g. substitution of Ca²⁺ with Mg²⁺). “Aliovalent substitution” refers to a substitution of one element on a given crystallographic site with an element of a different oxidation state (e.g. substitution of Li⁺ with Mg²⁺).

For all embodiments described herein where MI is partially substituted by MII by isocharge substitution, MI may be substituted by an equal stoichiometric amount of MII, whereby M=MIₙ₋ₒMIIₒ. Where MI is partially substituted by MI by isocharge substitution and the stoichiometric amount of MI is not equal to the amount of MII, whereby M=MIₙ₋ₒMIIₚ and o≠p, then the stoichiometric amount of one or more of the other components (e.g. A, L and Z) in the active material must be adjusted in order to maintain electroneutrality.

For all embodiments described herein where MI is partially substituted by MII by aliovalent substitution and an equal amount of MI is substituted by an equal amount of MII, whereby M=MIₙ₋ₒMIIₒ, then the stoichiometric amount of one or more of the other components (e.g. A, L and Z) in the active material must be adjusted in order to maintain electroneutrality. However, MI may be partially substituted by MII by aliovalent substitution by substituting an “oxidatively” equivalent amount of MII for MI, whereby

$$M = {MI}_{n - \frac{o}{{V}^{MI}}} {MII}_{\frac{o}{{V}^{MII}}} ,$$

wherein V^{MI} is the oxidation state of MI, and V^{MII} is the oxidation state of MII.

In one subembodiment, MI is selected from the group consisting of Ti, V, Cr, Mn, Fe, Co, Ni, Cu, Mo, Si, Pb, Mo, Nb, and mixtures thereof, and MII is selected from the group consisting of Be, Mg, Ca, Sr, Ba, Sc, Y, Zn, Cd, B, Al, Ga, In, C, Ge, and mixtures thereof. In this subembodiment, MI may be substituted by MII by isocharge substitution or aliovalent substitution.

In another subembodiment, MI is partially substituted by MII by isocharge substitution. In one aspect of this subembodiment, MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Be²⁺, Mg²⁺, Ca²⁺, Sr²⁺, Ba²⁺, Zn²⁺, Cd²⁺, Ge²⁺, and mixtures thereof. In another aspect of this subembodiment, MI is selected from the group specified immediately above, and MII is selected from the group consisting of Be²⁺, Mg²⁺, Ca²⁺, Sr²⁺, Ba²⁺, and mixtures thereof. In another aspect of this subembodiment, MI is selected from the group specified above, and MII is selected from the group consisting of Zn²⁺, Cd²⁺, and mixtures thereof. In yet another aspect of this subembodiment, MI is selected from the group consisting of Ti³⁺, V³⁺, Cr³⁺, Mn³⁺, Fe³⁺, Co³⁺, Ni³⁺, Mo³⁺, Nb³⁺, and mixtures thereof, and Mil is selected from the group consisting of Sc³⁺, Y³⁺, B³⁺, Al³⁺, Ga³⁺, In³⁺, and mixtures thereof.

In another embodiment, MI is partially substituted by MII by aliovalent substitution. In one aspect of this subembodiment, MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Sc³⁺, Y³⁺, B³⁺, Al³⁺, Ga³⁺, In³⁺, and mixtures thereof. In another aspect of this subembodiment, MI is a 2+ oxidation state redox active element selected from the group specified immediately above, and MII is selected from the group consisting of alkali metals, Cu¹⁺, Ag¹⁺ and mixtures thereof. In another aspect of this subembodiment, MI is selected from the group consisting of Ti³⁺, V³⁺, Cr³⁺, Mn³⁺, Fe³⁺, Co³⁺, Ni³⁺, Mo³⁺, Nb³⁺, and mixtures thereof, and MII is selected from the group consisting of Be²⁺, Mg²⁺, Ca²⁺, Sr²⁺, Ba²⁺, Zn²⁺, Cd²⁺, Ge²⁺, and mixtures thereof. In another aspect of this subembodiment, MI is a 3+ oxidation state redox active element selected from the group specified immediately above, and MII is selected from the group consisting of alkali metals, Cu¹⁺, Ag¹⁺ and mixtures thereof.

In another embodiment, M=M1_{q}M2ᵣM3ₛ, wherein:
(i) M1 is a redox active element with a 2+ oxidation state;
(ii) M2 is selected from the group consisting of redox and non-redox active elements with a 1+ oxidation state;
(iii) M3 is selected from the group consisting of redox and non-redox active elements with a 3+ or greater oxidation state; and
(iv) at least one of q, r and s is greater than 0, and at least one of M1, M2, and M3 is redox active.

In one subembodiment, M1 is substituted by an equal amount of M2 and/or M3, whereby q=q−(r+s). In this subembodiment, then the stoichiometric amount of one or more of the other components (e.g. A, L and Z) in the active material must be adjusted in order to maintain electroneutrality.

In another subembodiment, M1 is substituted by an “oxidatively” equivalent amount of M2 and/or M3, whereby

$$M = M {1}_{q \frac{r}{{V}^{M 1}} \frac{s}{{V}^{M 1}}} M {2}_{\frac{r}{{V}^{M 2}}} M {3}_{\frac{s}{{V}^{M 3}}} ,$$

wherein V^{M1} is the oxidation state of M1, V^{M2} is the oxidation state of M2, and V^{M3} is the oxidation state of M3.

In one subembodiment, M1 is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of Cu¹⁺, Ag¹⁺ and mixtures thereof; and M3 is selected from the group consisting of Ti³⁺, V³⁺, Cr³⁺, Mn⁺, Fe³⁺, Co³⁺, Ni³⁺, Mo³⁺, Nb³⁺, and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In another subembodiment, M1 is selected from the group consisting of Be²⁺, Mg²⁺, Ca²⁺, Sr²⁺, Ba²⁺, Zn²⁺, Cd²⁺, Ge²⁺, and mixtures thereof; M2 is selected from the group consisting of Cu¹⁺, Ag¹⁺ and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In another subembodiment, M1 is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of Cu¹⁺, Ag¹⁺, and mixtures thereof; and M3 is selected from the group consisting of Sc³⁺, Y³⁺, B³⁺, Al³⁺, Ga³⁺, In³⁺ and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In all embodiments described herein, composition variable L is a polyanion selected from the group consisting of X′[O₄₋ₓ,Y′ₓ], X′[O_{4-y},Y′_{2y}], X″S₄, [X_{z}′″,X′_{1-z}]O₄, and mixtures thereof, wherein:
(a) X′ and X′″ are each independently selected from the group consisting of P, As, Sb, Si, Ge, V, S, and mixtures thereof;
(b) X″ is selected from the group consisting of P, As, Sb, Si, Ge, V, and mixtures thereof;
(c) Y′ is selected from the group consisting of a halogen, S, N, and mixtures thereof; and
(d) 0≦x≦3, 0≦y≦2, 0≦z≦1, and 1≦c≦3.

In one embodiment, composition variable L is selected from the group consisting of X′O₄₋ₓY′ₓ, X′O_{4-y}Y′_{2y}, and mixtures thereof, and x and y are both 0 (x,y=0). Stated otherwise, composition variable L is a polyanion selected from the group consisting of PO₄, SiO₄, GeO₄, VO₄, AsO₄, SbO₄, SO₄, and mixtures thereof. Preferably, composition variable L is PO₄ (a phosphate group) or a mixture of PO₄ with another anion of the above-noted group (i.e., where X′ is not P, Y′ is not O, or both, as defined above). In one embodiment, composition variable L includes about 80% or more phosphate and up to about 20% of one or more of the above-noted polyanions.

In another embodiment, composition variable L is selected from the group consisting of X′[O₄₋ₓ,Y′ₓ], X′[O_{4-y},Y′_{2y}] and mixtures thereof, and 0<x≦3 and 0<y≦2, wherein a portion of the oxygen (O) in the XY₄ composition variable is substituted with a halogen, S, N, or a mixture thereof.

In all embodiments described herein, composition variable Z (when provided) is selected from the group consisting of a hydroxyl (OH), a halogen selected from Group 17 of the Periodic Table, and mixtures thereof. In one embodiment, Z is selected from the group consisting of OH, F (Fluorine), Cl (Chlorine), Br (Bromine), and mixtures thereof. In another embodiment, Z is OH. In another embodiment, Z is F, or a mixture of F with OH, Cl, or Br.

In one particular subembodiment, the positive electrode film 26 contains a positive electrode active material represented by the general formula (2):

AₐM_{b}PO₄Z_{d}, (2)

wherein composition variables A, M, and Z are as described herein above, 0.1<a≦4, 8≦b≦1.2 and 0≦d≦4; and wherein A, M, Z, a, b, and d are selected so as to maintain electroneutrality of the electrode active material in its nascent or as-synthesized state. Specific examples of electrode active materials represented by general formula (2), wherein d>0, include Li₂Fe_{0.9}Mg_{0.1}PO4F, Li₂Fe_{0.8}Mg_{0.2}PO₄F, Li₂Fe_{0.95}Mg_{0.05}PO₄F, Li₂CoPO₄F, Li₂FePO₄F, and Li₂MnPO₄F.

In a subembodiment, M includes at least one element from Groups 4 to 11 of the Periodic Table, and at least one element from Groups 2, 3, and 12-16 of the Periodic Table. In a particular subembodiment, M includes an element selected from the group consisting of Fe, Co, Mn, Cu, V, Cr, and mixtures thereof; and a metal selected from the group consisting of Mg, Ca, Zn, Ba, Al, and mixtures thereof.

In another subembodiment, the positive electrode film 26 contains a positive electrode active material represented by the general formula (3):

AM′₁₋ⱼM″ⱼPO₄, (3)

wherein composition variable A is as described herein above, and wherein M′ is at least one transition metal from Groups 4 to 11 of the Periodic Table and has a+2 valence state; M″ is at least one metallic element which is from Group 2, 12, or 14 of the Periodic Table and has a +2 valence state; and 0<j<1. In one subembodiment, M′ is selected from the group consisting of Fe, Co, Mn, Cu, V, Cr, Ni, and mixtures thereof; more preferably M′ is selected from Fe, Co, Ni, Mn and mixtures thereof. Preferably, M″ is selected from the group consisting of Mg, Ca, Zn, Ba, and mixtures thereof.

In another subembodiment, the positive electrode film 26 contains a positive electrode active material represented by the general formula (4):

LiFe₁₋ₖM″ₖPO₄, (4)

wherein M″ is selected from the group consisting of Mg, Ca, Zn, Sr, Pb, Cd, Sn, Ba, Be, and mixtures thereof; and 0<k<1. In one subembodiment, 0<k≦0.2. In a another subembodiment, M is selected from the group consisting of Mg, Ca, Zn, Ba, and mixtures thereof, more preferably, M″ is Mg. In another subembodiment the electrode active material is represented by the formula LiFe₁₋ₖMgₖPO₄, wherein 0<k≦0.5. Specific examples of electrode active materials represented by general formula (4) include LiFe_{0.8}Mg_{0.2}PO₄, LiFe_{0.9}Mg_{0.1}PO₄, and LiFe_{0.95}Mg_{0.05}PO₄.

In another subembodiment, the positive electrode film 26 contains a positive electrode active material represented by the general formula (5):

AₐCoᵤFeᵥM¹³_{w}M¹⁴ₐₐM¹⁵_{bb}L, (5)

wherein:
(i) composition variable A is as described herein above, 0<a≦2
(ii) u>0 and v>0;
(iii) M¹³ is one or more transition metals, wherein w≧0;
(iv) M¹⁴ is one or more +2 oxidation state non-transition metals, wherein aa≧0;
(v) M¹⁵ is one or more +3 oxidation state non-transition metals, wherein bb≧0;
(vi) L is selected from the group consisting of X′O₄₋ₓY′ₓ, X′O_{4-y}Y′_{2y}, X″S₄, and mixtures thereof, where X′ is selected from the group consisting of P, As, Sb, Si, Ge, V, S, and mixtures thereof; X″ is selected from the group consisting of P, As, Sb, Si, Ge, V and mixtures thereof; Y′ is selected from the group consisting of halogen, S, N, and mixtures thereof; 0≦x≦3; and 0<y≦2; and

wherein 0<(u+v+w+aa+bb)<2, and M¹³, M¹⁴, M¹⁵, L, a, u, v, w, aa, bb, x, and y are selected so as to maintain electroneutrality of the electrode active material in its nascent or as-synthesized state. In one subembodiment, 0.8≦(u+v+w+aa+bb)≦1.2, wherein u≧0.8 and 0.05≦v≦0.15. In another subembodiment, 0.8≦(u+v+w+aa+bb)≦1.2, wherein u≧0.5, 0.01≦v≦0.5, and 0.01≦w≦0.5.

In one subembodiment, M¹³ is selected from the group consisting of Ti, V, Cr, Mn, Ni, Cu and mixtures thereof. In another subembodiment, M¹³ is selected from the group consisting of Mn, Ti, and mixtures thereof. In another subembodiment, M¹⁴ is selected from the group consisting of Be, Mg, Ca, Sr, Ba, and mixtures thereof. In one particular subembodiment, M¹⁴ is Mg and 0.01≦bb≦0.2, preferably 0.01≦bb≦0.1. In another particular subembodiment, M¹⁵ is selected from the group consisting of B, Al, Ga, In, and mixtures thereof.

In another subembodiment, the positive electrode film 26 contains a positive electrode active material represented by the general formula (6):

LiM(PO₄₋ₓY′ₓ), (6)

wherein M is M¹⁶_{cc}M¹⁷_{dd}M¹⁸ₑₑM¹⁹_{ff}, and
(i) M¹⁶ is one or more transition metals;
(ii) M¹⁷ is one or more +2 oxidation state non-transition metals;
(iii) M¹⁸ is one or more +3 oxidation state non-transition metals;
(iv) M¹⁹ is one or more +1 oxidation state non-transition metals;
(v) Y′ is halogen; and
   wherein cc>0, each of dd, ee, and ff≧0, (cc+dd+ee+ff)≦1, and 0≦x≦0.2, and M¹⁶, M¹⁷, M¹⁸, M¹⁹, Y, cc, dd, ee, ff, and x are selected so as to maintain electroneutrality of the electrode active material in its nascent or as-synthesized state. In one subembodiment, cc≧0.8. In another subembodiment, 0.01≦(dd+ee)≦0.5, preferably 0.01≦dd≦0.2 and 0.01≦ee≦0.2. In another subembodiment x=0.

In one particular subembodiment, M¹⁶ is a +2 oxidation state transition metal selected from the group consisting of V, Cr, Mn, Fe, Co, Cu, and mixtures thereof. In another subembodiment, M¹⁶ is selected from the group consisting of Fe, Co, and mixtures thereof. In a preferred subembodiment M¹⁷ is selected from the group consisting of Be, Mg, Ca, Sr, Ba and mixtures thereof. In a preferred subembodiment M¹⁸ is Al. In one subembodiment, M¹⁹ is selected from the group consisting of Li, Na, and K, wherein 0.01≦ff≦0.2. In a preferred subembodiment M¹⁹ is Li. In one preferred subembodiment x=0, (cc+dd+ee+ff)=1, M¹⁷ is selected from the group consisting of Be, Mg, Ca, Sr, Ba and mixtures thereof, preferably 0.01≦dd≦0.1, M¹⁸ is Al, preferably 0.01≦ee≦0.1, and M¹⁹ is Li, preferably 0.01≦ff≦0.1. In another preferred subembodiment, 0<x≦0, preferably 0.01≦x≦0.05, and (cc+dd+ee+ff)<1, wherein cc≧0.8, 0.01≦dd≦0.1, 0.01≦ee≦0.1 and ff=0. Preferably (cc+dd+ee)=1−x.

In another subembodiment, the positive electrode film 26 contains a positive electrode active material represented by the general formula (7):

A¹ₐ(MO)_{gg}M′_{1-gg}XO₄, (7)

wherein
(i) A¹ is independently selected from the group consisting of Li, Na, K and mixtures thereof, 0.1<a<2;
(ii) M comprises at least one element, having a +4 oxidation state, which is redox active; 0<gg≦1;
(iii) M′ is one or more metals selected from metals having a +2 and a +3 oxidation state; and
(iv) X is selected from the group consisting of P, As, Sb, Si, Ge, V, S, and mixtures thereof; and

wherein A¹, M, M′, X, a and gg are selected so as to maintain electroneutrality of the electrode active material in its nascent or as-synthesized state.

In one subembodiment, A¹ is Li. In another subembodiment, M is selected from a group consisting of +4 oxidation state transition metals. In a preferred subembodiment, M is selected from the group comprising Vanadium (V), Tantalum (Ta), Niobium (Nb), molybdenum (Mo), and mixtures thereof. In another preferred subembodiment M comprises V, and b=1. M′ may generally be any +2 or +3 element, or mixture of elements. In one subembodiment, M′ is selected from the group consisting V, Cr, Mn, Fe, Co, Ni, Mo, Ti, Al, Ga, In, Sb, Bi, Sc, and mixtures thereof. In another subembodiment, M′ is selected from the group consisting of V, Cr, Mn, Fe, Co, Ni, Ti, Al, and mixtures thereof. In one preferred subembodiment, M′ comprises Al. Specific examples of electrode active materials represented by general formula (7) include LiVOPO₄, Li(VO)_{0.75}Mn_{0.25}PO₄, Li_{0.75}Na_{0.25}VOPO₄, and mixtures thereof.

In another subembodiment, the positive electrode film 26 contains a positive electrode active material represented by the general formula (8):

AₐM_{b}L₃Z_{d}, (8)

wherein composition variables A, M XY₄ and Z are as described herein above, 2≦a≦8, 1≦b≦3, and 0≦d≦6; and

wherein M, L, Z, a, b, d, x and y are selected so as to maintain electroneutrality of the electrode active material in its nascent or as-synthesized state.

In one subembodiment, A is Li, or a mixture of Li with Na or K. In another preferred embodiment, A is Na, K, or a mixture thereof. In another subembodiment, M is selected from the group consisting of Fe, Co, Ni, Mn, Cu, V, Zr, Ti, Cr, and mixtures thereof. In another subembodiment, M comprises two or more transition metals from Groups 4 to 11 of the Periodic Table, preferably transition metals selected from the group consisting of Fe, Co, Ni, Mn, Cu, V, Zr, Ti, Cr, and mixtures thereof. In subembodiment, M comprises M′₁₋ₘM″ₘ, where M′ is at least one transition metal from Groups 4 to 11 of the Periodic Table; and M″ is at least one element from Groups 2, 3, and 12-16 of the Periodic Table; and 0<m<1. Preferably, M′ is selected from the group consisting of Fe, Co, Ni, Mn, Cu, V, Zr, Ti, Cr, and mixtures thereof; more preferably M′ is selected from the group consisting of Fe, Co, Mn, Cu, V, Cr, and mixtures thereof. Preferably, M″ is selected from the group consisting of Mg, Ca, Zn, Sr, Pb, Cd, Sn, Ba, Be, Al, and mixtures thereof; more preferably, M″ is selected from the group consisting of Mg, Ca, Zn, Ba, Al, and mixtures thereof. In a preferred embodiment, XY₄ is PO₄. In another subembodiment, X′ comprises As, Sb, Si, Ge, S, and mixtures thereof; X″ comprises As, Sb, Si, Ge and mixtures thereof; and 0<x<3. In a preferred embodiment, Z comprises F, or mixtures of F with Cl, Br, OH, or mixtures thereof. In another preferred embodiment, Z comprises OH, or mixtures thereof with Cl or Br. One particular example of an electrode active material represented by general formula (8) is Li₃V₂(PO₄)₃.

Non-limiting examples of active materials represented by general formulas (1) through (8) include the following: Li_{0.95}Co_{0.8}Fe_{0.15}Al_{0.05}PO₄, Li_{1.025}Co_{0.85}Fe_{0.05}Al_{0.025}Mg_{0.05}PO₄, Li_{1.025}Co_{0.80}Fe_{0.10}Al_{0.025}Mg_{0.05}PO₄, Li_{1.025}Co_{0.45}Fe_{0.45}Al_{0.025}Mg_{0.05}PO₄, Li_{1.025}Cu_{0.75}Fe_{0.15}Al_{0.025}Mg_{0.05}PO₄, Li_{1.025}Co_{0.7}(Fe_{0.4}Mn_{0.6})_{0.2}Al_{0.025}Mg_{0.05}PO₄, Li_{1.025}Co_{0.75}Fe_{0.15}Al_{0.025}Mg_{0.05}PO₄, Li_{1.025}Co_{0.85}Fe_{0.05}Al_{0.025}Mg_{0.05}PO₄, Li_{1.025}Co_{0.7}Fe_{0.08}Mn_{0.12}Al_{0.025}Mg_{0.05}PO₄, LiCo_{0.75}Fe_{0.15}Al_{0.025}Ca_{0.05}PO_{3.975}F_{0.025}, LiCo_{0.80}Fe_{0.10}Al_{0.025}Ca_{0.05}PO_{3.975}F_{0.025}, Li_{1.25}Co_{0.6}Fe_{0.1}Mn_{0.075}Mg_{0.025}Al_{0.05}PO₄, Li_{1.0}Na_{0.25}Co_{0.6}Fe_{0.1}Cu_{0.075}Mg_{0.025}A_{0.05}PO₄, Li_{1.025}Cu_{0.8}Fe_{0.1}Al_{0.025}Mg_{0.075}PO₄, Li_{1.025}Co_{0.6}Fe_{0.05}Al_{0.12}Mg_{0.0325}PO_{3.75}F_{0.25}, Li_{1.025}Co_{0.7}Fe_{0.1}Mg_{0.0025}Al_{0.04}PO_{3.75}F_{0.25}, Li_{0.75}Cu_{0.5}Fe_{0.05}Mg_{0.015}Al_{0.04}PO₃F, Li_{0.75}Cu_{0.5}Fe_{0.025}Cu_{0.025}Be_{0.015}Al_{0.04}PO₃F, Li_{0.75}Co_{0.5}Fe_{0.025}Mn_{0.025}Ca_{0.015}Al_{0.04}PO₃F, Li_{1.025}Co_{0.6}Fe_{0.05}B_{0.12}Ca_{0.0325}PO_{3.75}F_{0.25}, Li_{1.025}Co_{0.65}Fe_{0.05}Mg_{0.0125}Al_{0.1}PO_{3.75}F_{0.25}, Li_{1.025}Cu_{0.65}Fe_{0.05}Mg_{0.065}Al_{0.14}PO_{3.975}F_{0.025}; Li_{1.075}Co_{0.8}Fe_{0.05}Mg_{0.025}Al_{0.05}PO_{3.975}F_{0.025}, LiCo_{0.8}Fe_{0.1}Al_{0.025}Mg_{0.05}PO_{3.975}F_{0.025}, Li_{0.25}Fe_{0.7}Al_{0.45}PO₄, LiMnAl_{0.067}(PO₄)_{0.8}(SiO₄)_{0.2}, Li_{0.95}Co_{0.9}Al_{0.05}Mg_{0.05}PO₄, Li_{0.95}Fe_{0.8}Ca_{0.15}Al_{0.05}PO₄, Li_{0.25}MnBe_{0.425}Ga_{0.3}SiO₄, Li_{0.5}Na_{0.25}Mn_{0.6}Ca_{0.375}Al_{0.1}PO₄, Li_{0.25}Al_{0.25}Mg_{0.25}Co_{0.75}PO₄, Na_{0.55}B_{0.15}Ni_{0.75}Ba_{0.25}PO₄, Li_{1.025}Co_{0.9}Al_{0.025}Mg_{0.05}PO₄, K_{1.025}Ni_{0.09}Al_{0.025}Ca_{0.05}PO₄, Li_{0.95}Co_{0.9}Al_{0.05}Mg_{0.05}PO₄, Li_{0.95}Fe_{0.8}Ca_{0.15}Al_{0.05}PO₄,

Li_{1.025}Co_{0.7}(Fe_{0.4}Mn_{0.6})_{0.2}Al_{0.025}Mg_{0.05}PO₄, Li_{1.025}Cu_{0.8}Fe_{0.1}Al_{0.025}Mg_{0.05}PO₄, Li_{1.025}Co_{0.9}Al_{0.025}Mg_{0.05}PO₄, Li_{1.025}Co_{0.75}Fe_{0.15}Al_{0.025}Mg_{0.025}PO₄,

LiCo_{0.75}Fe_{0.15}Al_{0.025}Ca_{0.05}PO_{3.975}F_{0.025}, LiCo_{0.9}Al_{0.025}Mg_{0.05}PO_{3.975}F_{0.025},

Li_{0.75}Cu_{0.625}Al_{0.25}PO_{3.75}F_{0.25}, Li_{1.075}Co_{0.8}Cu_{0.05}Mg_{0.025}Al_{0.05}PO_{3.975}F_{0.025}, Li_{1.075}Fe_{0.8}Mg_{0.075}Al_{0.05}PO_{3.975}F_{0.025}, Li_{1.075}Co_{0.8}Mg_{0.075}Al_{0.05}PO_{3.975}F_{0.025}, Li_{1.025}Co_{0.8}Mg_{0.1}Al_{0.05}PO_{3.975}F_{0.025}, LiCo_{0.7}Fe_{0.2}Al_{0.025}Mg_{0.05}PO_{3.975}F_{0.025},

Li₂Fe_{0.8}Mg_{0.2}PO₄F; Li₂Fe_{0.5}Co_{0.5}PO₄F; Li₃CoPO₄F₂; KFe(PO₃F)F; Li₂Co(PO₃F)Br₂; Li₂Fe(PO₃F₂)F; Li₂FePO₄Cl; Li₂MnPO₄OH; Li₂CoPO₄F; Li₂Fe_{0.5}Co_{0.5}PO₄F; Li₂Fe_{0.9}Mg_{0.1}, PO₄F; Li₂Fe_{0.8}Mg_{0.2}PO₄F; Li_{1.25}Fe_{0.9}Mg_{0.1}PO₄F_{0.25}; Li₂MnPO₄F; Li₂CoPO₄F; K₂Fe_{0.9}Mg_{0.1}P_{0.5}As_{0.5}O₄F; Li₂MnSbO₄OH; Li₂Fe_{0.6}Co_{0.4}SbO₄Br; Na₃CoAsO₄F₂; LiFe(AsO₃F)Cl; Li₂Co(As_{0.5}Sb_{0.5}O₃F)F₂; K₂Fe(AsO₃F₂)F; Li₂NiSbO₄F; Li₂FeAsO₄OH; Li₄Mn₂(PO₄)₃F; Na₄FeMn(PO₄)₃OH; Li₄FeV(PO₄)₃Br; Li₃VAl(PO₄)₃F; K₃VAl(PO₄)₃Cl; LiKNaTiFe(PO₄)₃F; Li₄Ti₂(PO₄)₃Br; Li₃V₂(PO₄)₃F₂; Li₆FeMg(PO₄)₃OH; Li₄Mn₂(AsO₄)₃F; K₄FeMn(AsO₄)₃OH; Li₄FeV(P_{0.5}Sb_{0.5}O₄)₃Br; LiNaKAlV(AsO₄)₃F; K₃VAl(SbO₄)₃Cl; Li₃TiV(SbO₄)₃F; Li₂FeMn(P_{0.5}As_{0.5}O₃F)₃; Li₄Ti₂(PO₄)₃F; Li_{3.25}V₂(PO₄)₃F_{0.25}; Li₃Na_{0.75}Fe₂(PO₄)₃F_{0.75}; Na_{6.5}Fe₂(PO₄)₃(OH)Cl_{0.5}; K₈Ti₂(PO₄)₃F₃Br₂; K₈Ti₂(PO₄)₃F₅; Li₄Ti₂(PO₄)₃F; LiNa_{1.25}V₂(PO₄)₃F_{0.5}Cl_{0.75}; K_{3.25}Mn₂(PO₄)₃OH_{0.25}; LiNa_{1.25}KTiV(PO₄)₃(OH)_{1.25}Cl; Na₈Ti₂(PO₄)₃F₃Cl₂; Li₇Fe₂(PO₄)₃F₂; Li₈FeMg(PO₄)₃F_{2.25}Cl_{0.75}; Li₅Na_{2.5}TiMn(PO₄)₃(OH)₂Cl_{0.5}; Na₃K_{4.5}MnCa(PO₄)₃(OH)_{1.5}Br; KgFeBa(PO₄)₃F₂Cl₂; Li₇Ti₂(SiO₄)₂(PO₄)F₂; Na₈Mn₂(SiO₄)₂(PO₄)F₂Cl; Li₃K₂V₂(SiO₄)₂(PO₄)(OH)Cl; Li₄Ti₂(SiO₄)₂(PO₄)(OH); Li₂NaKV₂(SiO₄)₂(PO₄)F; Li₅TiFe(PO₄)₃F; Na₄K₂VMg(PO₄)₃FCl; Li₄NaAlNi(PO₄)₃(OH); Li₄K₃FeMg(PO₄)₃F₂; Li₂Na₂K₂CrMn(PO₄)₃(OH)Br; Li₅TiCa(PO₄)₃F; Li₄Ti_{0.75}Fe_{1.5}(PO₄)₃F; Li₃NaSnFe(PO₄)₃(OH); Li₃NaGe_{0.5}Ni₂(PO₄)₃(OH); Na₃K₂VCo(PO₄)₃(OH)Cl; Li₄Na₂MnCa(PO₄)₃F(OH); Li₃NaKTiFe(PO₄)₃F; Li₇FeCo(SiO₄)₂(PO₄)F; Li₃Na₃TiV(SiO₄)₂(PO₄)F; K_{5.5}CrMn(SiO₄)₂(PO₄)Cl_{0.5}; Li₃Na_{2.5}V₂(SiO₄)₂(PO₄)(OH)_{0.5}; Na_{5.25}FeMn(SiO₄)₂(PO₄)Br_{0.25}; Li_{6.5}VCo(SiO₄)_{2.5}(PO₄)_{0.5}F; Na_{7.25}V₂(SiO₄)_{2.25}(PO₄)_{0.75}F₂; Li₄NaVTi(SiO₄)₃F_{0.5}Cl_{0.5}; Na₂K_{2.5}ZrV(SiO₄)₃F_{0.5}; Li₄K₂MnV(SiO₄)₃(OH)₂; Li₃Na₃KTi₂(SiO₄)₃F; K₆V₂(SiO₄)₃(OH)Br; Li₈FeMn(SiO₄)₃F₂; Na₃K_{4.5}MnNi(SiO₄)₃(OH)_{1.5}; Li₃Na₂K₂TiV(SiO₄)₃(OH)_{0.5}Cl_{0.5}; K₉VCr(SiO₄)₃F₂Cl; Li₄Na₄V₂(SiO₄)₃FBr; Li₄FeMg(SO₄)₃F₂; Na₂KNiCo(SO₄)₃(OH); Na₅MnCa(SO₄)₃F₂Cl; Li₃NaCoBa(SO₄)₃FBr; Li_{2.5}K_{0.5}FeZn(SO₄)₃F; Li₃MgFe(SO₄)₃F₂; Li₂NaCaV(SO₄)₃FCl; Na₄NiMn(SO₄)₃(OH)₂; Na₂ KBaFe(SO₄)₃F; Li₂KCuV(SO₄)₃(OH)Br; Li_{1.5}CoPO₄F_{0.5}; Li_{1.25}CoPO₄F_{0.25}; Li_{1.75}FePO₄F_{0.75}; Li_{1.66}MnPO₄F_{0.66}; Li_{1.5}Co_{0.75}Ca_{0.25}PO₄F_{0.5}; Li_{1.75}Co_{0.8}Mn_{0.2}PO₄F_{0.75}; Li_{1.25}Fe_{0.75}Mg_{0.25}PO₄F_{0.25}; Li_{1.66}Co_{0.6}Zn_{0.4}PO₄F_{0.66}; KMn₂SiO₄Cl; Li₂VSiO₄(OH)₂; Li₃CoGeO₄F; LiMnSO₄F; NaFe_{0.9}Mg_{0.1}SO₄Cl; LiFeSO₄F; LiMnSO₄OH; KMnSO₄F; Li_{1.75}Mn_{0.8}Mg_{0.2}PO₄F_{0.75}; Li₃FeZn (PO₄)F₂; Li_{0.5}V_{0.75}Mg_{0.5}(PO₄)F_{0.75}; Li₃V_{0.5}Al_{0.5}(PO₄)F_{3.5}; Li_{0.75}VCa(PO₄)F_{1.75}; Li₄CuBa(PO₄)F₄; Li_{0.5}V_{0.5}Ca(PO₄)(OH)_{1.5}; Li_{1.5}FeMg(PO₄)(OH)Cl; LiFeCoCa(PO₄)(OH)₃F; Li₃CoBa(PO₄)(OH)₂Br₂; Li_{0.75}Mn_{1.5}Al(PO₄)(OH)_{3.75}; Li₂Co_{0.75}Mg_{0.25}(PO₄)F; LiNaCo_{0.8}Mg_{0.2}(PO₄)F; NaKCo_{0.5}Mg_{0.5}(PO₄)F; LiNa_{0.5}K_{0.5}Fe_{0.75}Mg_{0.25}(PO₄)F; Li_{1.5}K_{0.5}V_{0.5}Zn_{0.5}(PO₄)F₂; Na₆Fe₂Mg(PS₄)₃(OH₂)Cl; Li₄Mn_{1.5}Co_{0.5}(PO₃F)₃(OH)_{3.5}; K₈FeMg(PO₃F)₃F₃Cl₃ Li₅Fe₂Mg(SO₄)₃Cl₅; LiTi₂(SO₄)₃Cl, LiMn₂(SO₄)₃F, Li₃Ni₂(SO₄)₃Cl, Li₃Co₂(SO₄)₃F, Li₃Fe₂(SO₄)₃Br, Li₃Mn₂(SO₄)₃F, Li₃MnFe(SO₄)₃F, Li₃NiCo(SO₄)₃Cl; LiMnSO₄F; LiFeSO₄Cl; LiNiSO₄F; LiCoSO₄Cl; LiMn₁₋ₓFeₓSO₄F, LiFe₁₋ₓMgₓSO₄F; Li₇ZrMn(SiO₄)₃F; Li₇MnCo(SiO₄)₃F; Li₇MnNi(SiO₄)₃F; Li₇VAl(SiO₄)₃F; Li₅MnCo(PO₄)₂(SiO₄)F; Li₄VAl(PO₄)₂(SiO₄)F; Li₄MnV(PO₄)₂(SiO₄)F; Li₄VFe(PO₄)₂(SiO₄)F; Li_{0.6}VPO₄F_{0.6}; Li_{0.8}VPO₄F_{0.8}; LiVPO₄F; Li₃V₂(PO₄)₂F₃; LiVPO₄Cl; LiVPO₄OH; NaVPO₄F; Na₃V₂(PO₄)₂F₃; LiV_{0.9}Al_{0.1}PO₄F; LiFePO₄F; LiTiPO₄F; LiCrPO₄F; LiFePO₄; LiCoPO₄, LiMnPO₄; LiFe_{0.9}Mg_{0.1}PO₄; LiFe_{0.8}Mg_{0.2}PO₄; LiFe_{0.95}Mg_{0.05}PO₄; LiFe_{0.9}Ca_{0.1}PO₄; LiFe_{0.8}Ca_{0.2}PO₄; LiFe_{0.8}Zn_{0.2}PO₄; LiMn_{0.8}Fe_{0.2}PO₄; LiMn_{0.9}Fe_{0.8}PO₄; Li₃V₂(PO₄)₃; Li₃Fe₂(PO₄)₃; Li₃Mn₂(PO₄)₃; Li₃FeTi(PO₄)₃; Li₃CoMn(PO₄)₃; Li₃FeV(PO₄)₃; Li₃VTi(PO₄)₃; Li₃FeCr(PO₄)₃; Li₃FeMo(PO₄)₃; Li₃FeNi(PO₄)₃; Li₃FeMn(PO₄)₃; Li₃FeAl(PO₄)₃; Li₃FeCo(PO₄)₃; Li₃Ti₂(PO₄)₃; Li₃TiCr(PO₄)₃; Li₃TiMn(PO₄)₃; Li₃TiMo(PO₄)₃; Li₃TiCo(PO₄)₃; Li₃TiAl(PO₄)₃; Li₃TiNi(PO₄)₃; Li₃ZrMnSiP₂O₁₂; Li₃V₂SiP₂O₁₂; Li₃MnVSiP₂O₁₂; Li₃TiVSiP₂O₁₂; Li₃TiCrSiP₂O₁₂; Li_{3.5}AlVSi_{0.5}P_{2.5}O₁₂; Li_{3.5}V2Si_{0.5}P_{2.5}O₁₂; Li_{2.5}AlCrSiO_{0.5}P_{2.5}O₁2; Li_{2.5}V₂P₃O_{11.5}F_{0.5}; Li₂V₂P₃O₁₁F; Li_{2.5}VMnP₃O_{11.5}F_{0.5}; Li₂V_{0.5}Fe_{1.5}P₃O₁₁F; Li₃V_{0.5}V_{1.5}P₃O_{11.5}F_{0.5}; Li₃V₂P₃O₁₁F; Li₃Mn_{0.5}V_{1.5}P₃O₁₁F_{0.5}; LiCo_{0.8}Fe_{0.1}Ti_{0.025}Mg_{0.05}PO₄; Li_{1.025}Co_{0.8}Fe_{0.1}Ti_{0.025}Al_{0.025}PO₄; Li_{1.025}Co_{0.8}Fe_{0.1}Ti_{0.025}Mg_{0.025}PO_{3.975}F_{0.025}; LiCo_{0.825}Fe_{0.1}Ti_{0.025}Mg_{0.025}PO₄; LiCo_{0.85}Fe_{0.075}Ti_{0.025}Mg_{0.025}PO₄; LiCo_{0.8}Fe_{0.1}Ti_{0.025}Al_{0.025}Mg_{0.025}PO₄, Li_{1.025}Co_{0.8}Fe_{0.1}Ti_{0.025}Mg_{0.05}PO₄, Li_{1.025}Co_{0.8}Fe_{0.1}Ti_{0.025}Al_{0.025}Mg_{0.025}PO₄, LiCo_{0.8}Fe_{0.1}Ti_{0.05}Mg_{0.05}PO₄, LiVOPO₄, Li(VO)_{0.75}Mn_{0.25}PO₄, NaVOPO₄, Li_{0.75}Na_{0.25}VOPO₄, Li(VO)_{0.5}Al_{0.5}PO₄, Na(VO)_{0.75}Fe_{0.25}PO₄, Li_{0.5}Na_{0.5}VOPO₄, Li(VO)_{0.75}Co_{0.25}PO₄, Li(VO)_{0.75}Mo_{0.25}PO₄, LiVOSO₄, and mixtures thereof.

Preferred active materials include LiFePO₄; LiCoPO₄, LiMnPO₄; LiMn_{0.8}Fe_{0.2}PO₄; LiMno_{0.9}Fe_{0.8}PO₄; LiFe_{0.9}Mg_{0.1}PO₄; LiFe_{0.8}Mg_{0.2}PO₄; LiFe_{0.95}Mg_{0.05}PO₄; Li_{1.025}Co_{0.85}Fe_{0.05}Al_{0.025}Mg_{0.05}PO₄, Li_{1.025}Co_{0.80}Fe_{0.10}Al_{0.025}Mg_{0.05}PO₄, Li_{1.025}Co_{0.75}Fe_{0.15}Al_{0.025}Mg_{0.05}PO₄, Li_{1.025}Co_{0.7}(Fe_{0.4}Mn_{0.6})_{0.2}Al_{0.025}Mg_{0.05}PO₄, LiCo_{0.8}Fe_{0.1}Al_{0.025}Ca_{0.05}PO_{3.975}F_{0.025}, LiCo_{0.8}Fe_{0.1}Al_{0.025}Mg_{0.05}PO_{3.975}F_{0.025}, LiCo_{0.8}Fe_{0.1}Ti_{0.025}Mg_{0.05}PO₄; Li_{1.025}Co_{0.8}Fe_{0.1}Ti_{0.025}Al_{0.025}PO₄; Li_{1.025}Co_{0.8}Fe_{0.1}Ti_{0.025}Mg_{0.025}PO_{3.975}F_{0.025}; LiCo_{0.825}Fe_{0.1}Ti_{0.025}Mg_{0.025}PO₄; LiCo_{0.85}Fe_{0.075}Ti_{0.025}Mg_{0.025}PO₄; LiVOPO₄; Li(VO)_{0.75}Mn_{0.25}PO₄; and mixtures thereof. A particularly preferred active material is LiCo_{0.8}Fe_{0.1}Al_{0.025}Mg_{0.05}PO_{3.975}F_{0.025}.

Active materials of general formulas (1) through (8) are readily synthesized by reacting starting materials in a solid state reaction, with or without simultaneous oxidation or reduction of the metal species involved. Sources of composition variable A include any of a number of salts or ionic compounds of lithium, sodium, potassium, rubidium or cesium. Lithium, sodium, and potassium compounds are preferred. Preferably, the alkali metal source is provided in powder or particulate form. A wide range of such materials is well known in the field of inorganic chemistry. Non-limiting examples include the lithium, sodium, and/or potassium fluorides, chlorides, bromides, iodides, nitrates, nitrites, sulfates, hydrogen sulfates, sulfites, bisulfites, carbonates, bicarbonates, borates, phosphates, hydrogen ammonium phosphates, dihydrogen ammonium phosphates, silicates, antimonates, arsenates, germinates, oxides, acetates, oxalates, and the like. Hydrates of the above compounds may also be used, as well as mixtures. In particular, the mixtures may contain more than one alkali metal so that a mixed alkali metal active material will be produced in the reaction.

Sources of composition variable M include salts or compounds of any of the transition metals, alkaline earth metals, or lanthanide metals, as well as of non-transition metals such as aluminum, gallium, indium, thallium, tin, lead, and bismuth. The metal compounds include, without limitation, fluorides, chlorides, bromides, iodides, nitrates, nitrites, sulfates, hydrogen sulfates, sulfites, bisulfites, carbonates, bicarbonates, borates, phosphates, hydrogen ammonium phosphates, dihydrogen ammonium phosphates, silicates, antimonates, arsenates, germanates, oxides, hydroxides, acetates, oxalates, and the like. Hydrates may also be used, as well as mixtures of metals, as with the alkali metals, so that alkali metal mixed metal active materials are produced. The elements or elements comprising composition variable M in the starting material may have any oxidation state, depending the oxidation state required in the desired product and the oxidizing or reducing conditions contemplated, as discussed below. The metal sources are chosen so that at least one metal in the final reaction product is capable of being in an oxidation state higher than it is in the reaction product.

Sources for composition variable L are provided by a number of salts or compounds containing positively charged cations in addition to the source of the polyanion or polyanions comprising composition variable L. Such cations include, without limitation, metal ions such as the alkali metals, alkaline metals, transition metals, or other non-transition metals, as well as complex cations such as ammonium or quaternary ammonium. The phosphate anion in such compounds may be phosphate, hydrogen ammonium phosphate, or dihydrogen ammonium phosphate. As with the alkali metal source and metal source discussed above, the phosphate or other XO₄ species, starting materials are preferably provided in particulate or powder form. Hydrates of any of the above may be used, as can mixtures of the above.

Sources of composition variable Z include any of a number of salts or ionic compounds of a halogen or hydroxyl. Non-limiting examples include the alkali-metal halides and hydroxides, and ammonium halides and hydroxides. Hydrates of the above compounds may also be used, as well as mixtures thereof. In particular, the mixtures may contain more than one alkali metal so that a mixed alkali metal active material will be produced in the reaction.

A starting material may provide more than one of composition variables A, M, and L and Z as is evident in the list above. In various embodiments of the invention, starting materials are provided that combine, for example, composition variable M and L, thus requiring only composition variable A and Z be added. In one embodiment, a starting material is provided that contains alkali metal, a metal, and phosphate. Combinations of starting materials providing each of the components may also be used. It is preferred to select starting materials with counterions that give rise to volatile by-products. Thus, it is desirable to choose ammonium salts, carbonates, oxides, and the like where possible. Starting materials with these counterions tend to form volatile by-products such as water, ammonia, and carbon dioxide, which can be readily removed from the reaction mixture. This concept is well illustrated in the Examples below.

The sources of composition variables A, M, L and Z, may be reacted together in the solid state while heating for a time and temperature sufficient to make a reaction product. The starting materials are provided in powder or particulate form. The powders are mixed together with any of a variety of procedures, such as by ball milling without attrition, blending in a mortar and pestle, and the like. Thereafter the mixture of powdered starting materials is compressed into a tablet and/or held together with a binder material to form a closely cohering reaction mixture. The reaction mixture is heated in an oven, generally at a temperature of about 400° C. or greater until a reaction product forms. Exemplary times and temperatures for the reaction are given in the Examples below.

Another means for carrying out the reaction at a lower temperature is hydrothermally. In a hydrothermal reaction, the starting materials are mixed with a small amount of a liquid such as water, and placed in a pressurized bomb. The reaction temperature is limited to that which can be achieved by heating the liquid water in a continued volume creating an increased pressure, and the particular reaction vessel used.

The reaction may be carried out without redox, or if desired under reducing or oxidizing conditions. When the reaction is done without redox, the oxidation state of the metal or mixed metals in the reaction product is the same as in the starting materials. Oxidizing conditions may be provided by running the reaction in air. Thus, oxygen from the air is used to oxidize the starting material containing the transition metal.

The reaction may also be carried out with reduction. For example, the reaction may be carried out in a reducing atmosphere such as hydrogen, ammonia, methane, or a mixture of reducing gases. Alternatively, the reduction may be carried out in-situ by including in the reaction mixture a reductant that will participate in the reaction to reduce the one or more elements comprising composition variable M, but that will produce by-products that will not interfere with the active material when used later in an electrode or an electrochemical cell. One convenient reductant to use to make the active materials of the invention is a reducing carbon. In a preferred embodiment, the reaction is carried out in an inert atmosphere such as argon, nitrogen, or carbon dioxide. Such reducing carbon is conveniently provided by elemental carbon, or by an organic material that can decompose under the reaction conditions to form elemental carbon or a similar carbon containing species that has reducing power. Such organic materials include, without limitation, glycerol, starch, sugars, cokes, and organic polymers which carbonize or pyrolize under the reaction conditions to produce a reducing form of carbon. A preferred source of reducing carbon is elemental carbon.

It is usually easier to provide the reducing agent in stoichiometric excess and remove the excess, if desired, after the reaction. In the case of the reducing gases and the use of reducing carbon such as elemental carbon, any excess reducing agent does not present a problem. In the former case, the gas is volatile and is easily separated from the reaction mixture, while in the latter, the excess carbon in the reaction product does not harm the properties of the active material, because carbon is generally added to the active material to form an electrode material for use in the electrochemical cells and batteries of the invention. Conveniently also, the by-products carbon monoxide or carbon dioxide (in the case of carbon) or water (in the case of hydrogen) are readily removed from the reaction mixture.

The carbothermal reduction method of synthesis of mixed metal phosphates has been described in PCT Publication WO01/53198, Barker et al., incorporated by reference herein. The carbothermal method may be used to react starting materials in the presence of reducing carbon to form a variety of products. The carbon functions to reduce a metal ion in the starting material M source. The reducing carbon, for example in the form of elemental carbon powder, is mixed with the other starting materials and heated. For best results, the temperature should be about 400° C. or greater, and up to about 950° C. Higher temperatures may be used, but are usually not required.

Methods of making the electrode active materials described by general formulas (1) through (8) are generally known in the art and described in the literature, and are also described in: WO 01/54212 to Barker et al., published Jul. 26, 2001; International Publication No. WO 98/12761 to Barker et al., published Mar. 26, 1998; WO 00/01024 to Barker et al., published Jan. 6, 2000; WO 00/31812 to Barker et al., published Jun. 2, 2000; WO 00/57505 to Barker et al., published Sep. 28, 2000; WO 02/44084 to Barker et al., published Jun. 6, 2002; WO 03/085757 to Saidi et al., published Oct. 16, 2003; WO 03/085771 to Saidi et al., published Oct. 16, 2003; WO 03/088383 to Saidi et al., published Oct. 23, 2003; U.S. Pat. No. 6,528,033 to Barker et al., issued Mar. 4, 2003; U.S. Pat. No. 6,387,568 to Barker et al., issued May 14, 2002; U.S. Publication No. 2003/0027049 to Barker et al., published Feb. 2, 2003; U.S. Publication No. 2002/0192553 to Barker et al., published Dec. 19, 2002; U.S. Publication No. 2003/0170542 to Barker at al., published Sep. 11, 2003; and U.S. Publication No. 2003/1029492 to Barker et al., published Jul. 10, 2003; the teachings of all of which are incorporated herein by reference.

As noted herein above, for all embodiments described herein, the negative electrode film 28 contains a negative electrode active material represented by the general formula (9):

E_{f}Ti_{g}DₕOᵢ, (9)

wherein:
(i) E is selected from the group consisting of elements from Group I of the Periodic Table, and mixtures thereof, and 0<f<12;
(ii) 0<g≦6;
(iii) D is selected from the group consisting of Al, Zr, Mg, Ca, Zn, Cd, Fe, Mn, Ni, Co, and mixtures thereof, and 0≦h≦2; and
(iv) 2≦i≦12.

wherein E, D, f, g, h and i are selected so as to maintain electroneutrality of the second counter-electrode active material in its nascent state.

For all embodiments described herein, composition variable E is selected from the group consisting of elements from Group I of the Periodic Table, and mixtures thereof (e.g. E_{f}=E_{f-f′}E′_{f}, wherein E and E′ are each selected from the group consisting of elements from Group I of the Periodic Table and are different from one another, and f′<f). In one subembodiment, in the positive and negative material's as-synthesized or nascent state, E and A share at least one common element (e.g. both E and A include the alkali-metal Li). In another subembodiment, in the positive and negative material's as-synthesized or nascent state, E and A do not share a common element.

In one subembodiment, 0<h≦2. In another subembodiment, 0<h≦2 and D is Al.

Non-limiting examples of active materials represented by general formula (10) include the following: Li₄Ti₅O₁₂; Li₅Ti₄AlO₁₂; rutile and anatase forms of TiO₂, including magneli type phases having the general formula TiₙO₂ₙ₋₁(4≦n≦9); TiO; Ti₄O₅; Ti₃O₅; LiTiO₂; Ti₄O₇; Li₂Ti₃O₇; and LiTi₂O₄.

In one subembodiment, the negative electrode active material is Li₄Ti₅O₁₂. The Li₄Ti₅O₁₂ negative electrode active material is characterized has having cubic spinel structure, space group Fd3m, the unit cell parameter a=8.3575(5) Å.

To prepare materials represented by general formula (10), starting materials are first selected to provide for composition variables A and (optionally) D, as well as elements Ti and O. A starting material may provide more than one of the components A, Ti, O and (optionally) D. In general, any anion may be combined with the alkali metal cation (composition variable A) to provide the alkali metal source starting material, with the Ti cation to provide a Ti-containing starting material, or with the elements comprising composition variable D to provide a D-containing starting material. It is preferred, however, to select starting materials with counterions that give rise to the formation of volatile by-products during the solid state reaction. Thus, it is desirable to choose ammonium salts, carbonates, bicarbonates, oxides, hydroxides, and the like where possible. Starting materials with these counterions tend to form volatile by-products such as water, ammonia, and carbon dioxide, which can be readily removed from the reaction mixture. Similarly, sulfur-containing anions such as sulfate, bisulfate, sulfite, bisulfite and the like tend to result in volatile sulfur oxide by-products. Nitrogen-containing anions such as nitrate and nitrite also tend to give volatile NOₓ by-products.

Sources of composition variable E include any of a number of salts or ionic compounds of lithium, sodium, potassium, rubidium or cesium. Lithium, sodium, and potassium compounds are preferred, with lithium being particularly preferred. Preferably, the alkali metal source is provided in powder or particulate form. A wide range of such materials is well known in the field of inorganic chemistry. Examples include the lithium, sodium, and/or potassium fluorides, chlorides, bromides, iodides, nitrates, nitrites, sulfates, hydrogen sulfates, sulfites, bisulfites, carbonates, bicarbonates, borates, phosphates, hydrogen ammonium phosphates, dihydrogen ammonium phosphates, silicates, antimonates, arsenates, germinates, oxides, acetates, oxalates, and the like. Hydrates of the above compounds may also be used, as well as mixtures. In particular, the mixtures may contain more than one alkali metal so that a mixed alkali metal active material will be produced in the reaction.

Suitable Ti-containing starting materials include TiO₂, Ti₂O₃, and TiO. Suitable D-containing starting materials include fluorides, chlorides, bromides, iodides, nitrates, nitrites, sulfates, hydrogen sulfates, sulfites, bisulfites, carbonates, bicarbonates, borates, phosphates, hydrogen ammonium phosphates, dihydrogen ammonium phosphates, silicates, antimonates, arsenates, germanates, oxides, hydroxides, acetates, oxalates, and the like. Hydrates may also be used.

The mixture of starting materials is heated for a time and at a temperature sufficient to form a reaction product. In one embodiment, the reaction is carried out in an oxidizing atmosphere so that titanium in the reaction product is present in the 4+ oxidation state. The temperature should preferably be about 400° C. or greater, and desirably between about 700° C. and 900° C.

Methods of making the negative electrode active materials described by general formula (9) are generally known in the art and described in the literature, and are also described in: U.S. Pat. No. 5,545,468 to Koshiba et al., issued Aug. 13, 1996; U.S. Pat. No. 6,827,921 to Singhal et al., issued Dec. 7, 2004; and U.S. Pat. No. 6,749,648 to Kumar et al., issued Jun. 15, 2004.

The following non-limiting examples illustrate the compositions and methods of the present invention.

### Example 1

A negative electrode active material of formula Li₄Ti₅O₁₂ is made according to the following reaction scheme.

2Li₂Co₃+5TiO₂→Li₄Ti₅O₁₂+2CO₂

To make Li₄Ti₅O₁₂, 4 g TiO₂ and 1.48 g of Li₂Co₃ are premixed, pelletized, placed in an oven and heated in a flowing argon atmosphere at a rate of 5° C./min to an ultimate temperature of 800° C. The temperature is maintained for 8 hours, after which the sample is cooled to room temperature and removed from the oven.

### Example 2

An electrode active material of formula Li₄Ti₅O₁₂ was made according to the following alternative reaction scheme.

2Li₂Co₃+5TiO₂+C→Li₄Ti₅O₁₂+2Co₂

To make Li₄Ti₅O₁₂, 7.98 grams TiO₂, 3.04 g of Li₂CO₃ and 0.56 g of Ensaco carbon black were micronized for 15 minutes, premixed, pelletized, placed in an oven and heated in a flowing argon atmosphere at a rate of 2° C./min to an ultimate temperature of 850° C. The temperature was maintained for 1 hour, after which the sample was cooled to room temperature and removed from the oven.

An electrode was made with ˜84% of the Li₄Ti₅O₁₂ active material (11.1 mg), 5% of Super P conductive carbon, and 11% PVdF-HFP co-polymer (Elf Atochem) binder. A cell with that electrode as cathode and a lithium-metal counter electrode was constructed with an electrolyte comprising 1M LiPF₆ solution in ethylene carbonate/dimethyl carbonate (2:1 by weight) while a dried glass fiber filter (Whatman, Grade GF/A) was used as electrode separator.

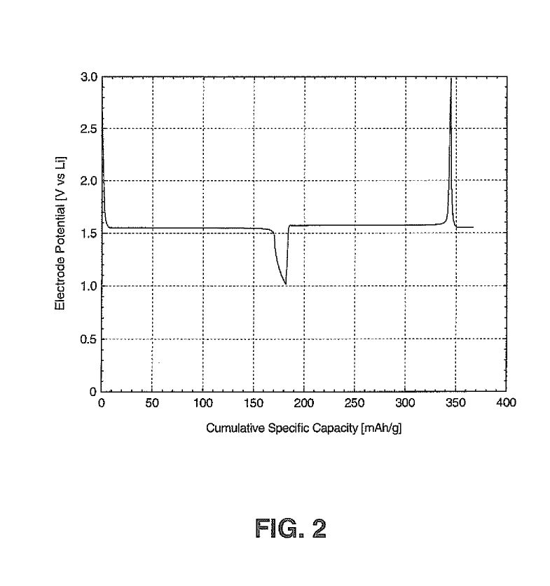

FIG. 2 is a plot of cathode specific capacity vs. cell voltage for the Li/1M LiPF₆ (EC/DMC)/Li₄Ti₅O₁₂ cell. The cell was cycled using constant current cycling at 0.1 milliamps per square centimeter (mA/cm²) in a range of 1 to 3 volts (V) at ambient temperature (˜23(C). The initial measured open circuit voltage (OCV) was approximately 3.02V vs. Li. The cathode material exhibited a 182 mA·h/g (milliamp-hour per gram) lithium insertion capacity, and a 163 mA·h/g lithium extraction capacity.

### Example 3

An electrode active material of formula Li₂Ti₃O₇ was made according to the following reaction scheme.

Li₂CO₃+3TiO₂→Li₂Ti₃O₇+Co₂

To make Li₂Ti₃O₇, 9.56 g TiO₂, 2.96 g of Li₂Co₃ and 0.62 g Ensaco carbon black were micronized for 15 minutes, premixed, pelletized, placed in an oven and heated in a flowing argon atmosphere at a rate of 2° C./min to an ultimate temperature of 750° C. The temperature was maintained for 4 hour, after which the sample was cooled to room temperature and removed from the oven.

An electrode was made with ˜84% of the Li₂Ti₃O₇ active material (10.7 mg), 5% of Super P conductive carbon, and 11% PVdF-HFP co-polymer (Elf Atochem) binder. A cell with that electrode as cathode and a lithium-metal counter electrode was constructed with an electrolyte comprising 1M LiPF₆ solution in ethylene carbonate/dimethyl carbonate (2:1 by weight) while a dried glass fiber filter (Whatman, Grade GF/A) was used as electrode separator.

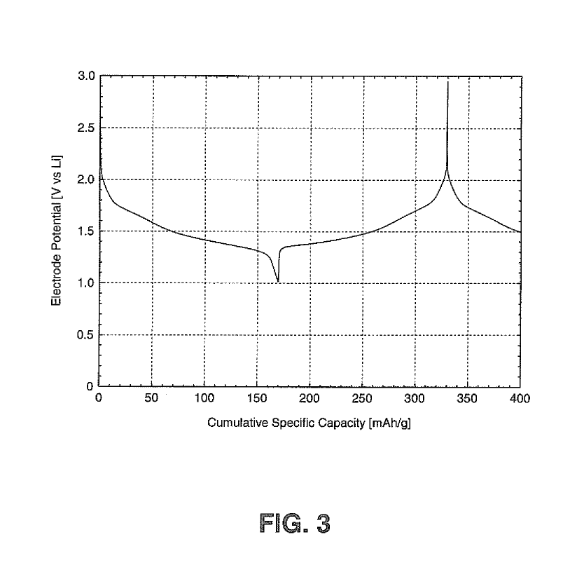

FIG. 3 is a plot of cathode specific capacity vs. cell voltage for the Li/1M LiPF₆ (EC/DMC)/Li₂Ti₃O₇ cell. The cell was cycled using constant current cycling at 0.1 milliamps per square centimeter (mA/cm²) in a range of 1 to 3 volts (V) at ambient temperature (˜23° C.). The initial measured open circuit voltage (OCV) was approximately 3.04V vs. Li. The cathode material exhibited a 172 mA·h/g lithium insertion capacity, and a 159 mA·h/g lithium extraction capacity.

### Example 4

An electrode active material of formula Li₂Ti₃O₇ was synthesized per the teachings of Example 3. A counter electrode active material of the formula LiVPO₄F was made as follows. In a first step, a metal phosphate was made by carbothermal reduction of a metal oxide, here exemplified by vanadium pentoxide. The overall reaction scheme of the carbothermal reduction is as follows.

0.5V₂O₅+NH₄H₂PO₄+C→VPO₄+xNH₃+xH₂O+xCO

7.28 g V₂O₅, 10.56 g (NH₄)₂HPO₄, and 0.96 g carbon black (Ensaco) were premixed using a mortar and pestle and then pelletized. The pellet was transferred to an oven equipped with a flowing argon atmosphere. The sample was heated at a ramp rate of 2° C. per minute to an ultimate temperature of 700° C. and maintained at this temperature for sixteen hours. The sample was cooled to room temperature, and then removed from the oven.

In a second step, the vanadium phosphate made in the first step was reacted with additional reactants, according to the following reaction scheme.

VPO₄+LiF→LiVPO₄F

To make LiVPO₄F, 2.04 g VPO₄ and 0.36 g LiF were premixed, pelletized, placed in an oven and heated at a ramp rate of 2° C. per minute to an ultimate temperature of 700° C., and maintained at that temperature for one hour, after which the sample was cooled to ambient temperature and removed from the oven.

A first electrode was made with ˜84% of the Li₂Ti₃O₇ active material (11.7 mg), 5% of Super P conductive carbon, and 11% PVdF-HFP co-polymer (Elf Atochem) binder. A second counter-electrode electrode was made with ˜84% of the LiVPO₄F active material (11.5 mg), 5% of Super P conductive carbon, and 11% PVdF-HFP co-polymer (Elf Atochem) binder.

A cell was constructed using the first and second electrodes and an electrolyte comprising 1M LiPF₆ solution in ethylene carbonate/dimethyl carbonate (2:1 by weight), while a dried glass fiber filter (Whatman, Grade GF/A) was used as electrode separator.

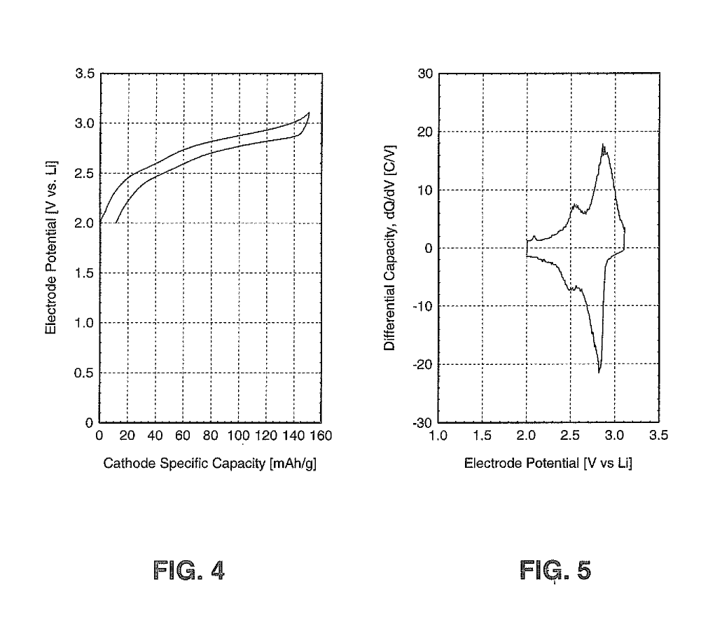

FIG. 4 shows the first cycle EVS results for the LiVPO₄F/1M LiPF₆ (EC/DMC)/Li₂Ti₃O₇ cell (voltage range: 2-3.2 V vs. Li; Critical current density <100 μA/cm²; voltage step=10 mV). The testing was carried out at ambient temperature (˜23° C.). The initial measured open circuit voltage (OCV) was approximately 1.55V. The fluorophosphate cathode material exhibited a 153 mA·h/g lithium extraction capacity, and a 142 mA·h/g lithium insertion capacity. The titanate anode material exhibited a 170 mA·h/g lithium insertion capacity, and a 158 mA·h/g lithium extraction capacity. The generally symmetrical nature of the charge-discharge curves further indicates the good reversibility of the system.

FIG. 5 is an EVS differential capacity plot based on FIG. 4. As can be seen from FIG. 5, the relatively symmetrical nature of the peaks indicates good electrical reversibility. There are small peak separations (charge/discharge), and good correspondence between peaks above and below the zero axis. There are essentially no peaks that can be related to irreversible reactions, since peaks above the axis (cell charge) have corresponding peaks below the axis (cell discharge), and there is very little separation between the peaks above and below the axis. This shows that the LiVPO₄F/Li₂Ti₃O₇ couple is suitable for use in a cell.

### Example 5

An electrode active material of formula Li₄Ti₅O₁₂ was synthesized per the teachings of Example 2, and a counter-electrode active material of the formula LiVPO₄F was synthesized per the teachings of Example 5.

Two LiVPO₄F/1M LiPF₆ (EC/DMC)/Li₄Ti₅O₁₂ cells were constructed per the teachings of Example 5 (cell 1: LiVPO₄F=12.2 mg, Li₄Ti₅O₁₂=12.5 mg) (cell 2: LiVPO₄F=10.3 mg, Li₄Ti₅O₁₂=10.6 mg).

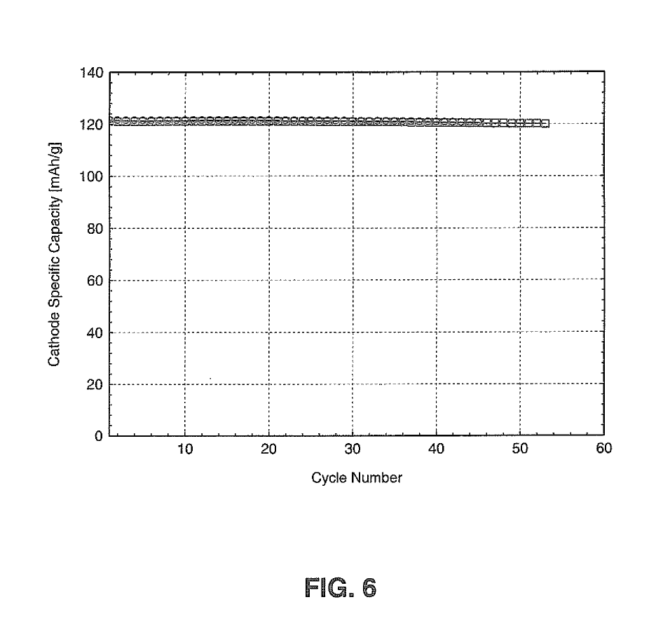

FIG. 5 presents data obtained by multiple constant current cycling at 0.1 milliamp hours per square centimeter of the two cells between 2 and 3 volts at ambient temperature (˜23° C.), carried out at a charge/discharge rate of C/2 (cell 1=□, cell 2=o). FIG. 6 shows the excellent rechargeability of the LiVPO₄F/1M LiPF₆ (EC/DMC)/Li₄Ti₅O₁₂ cells, and also shows good cycling and capacity of the cells.

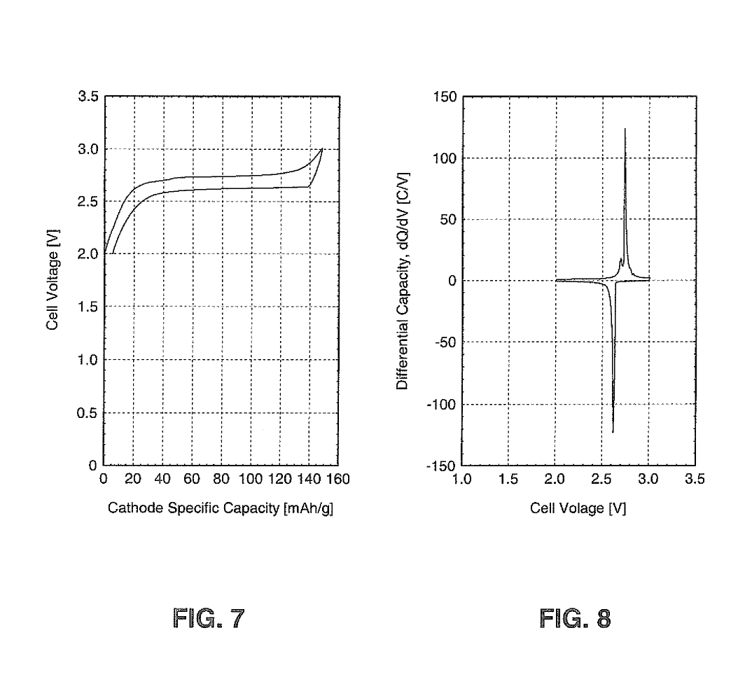

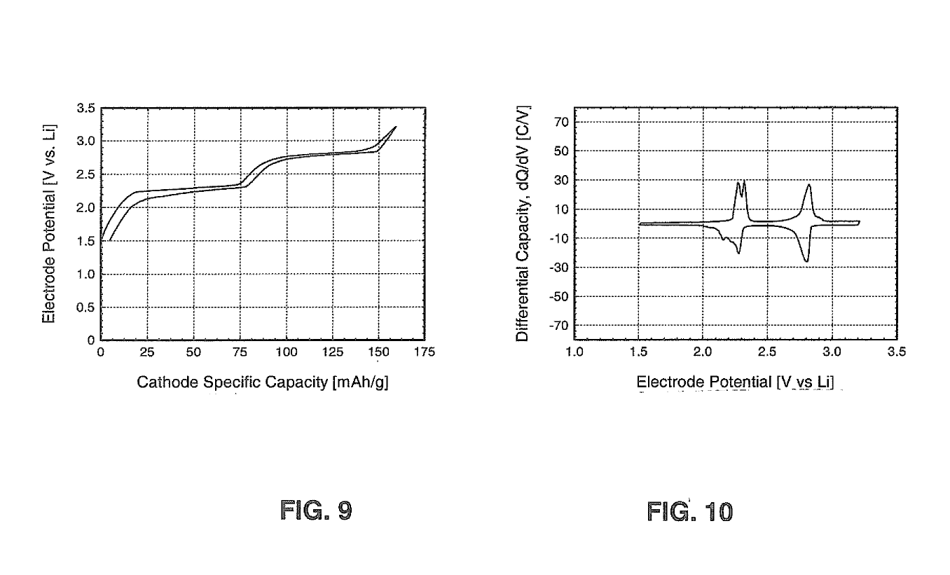

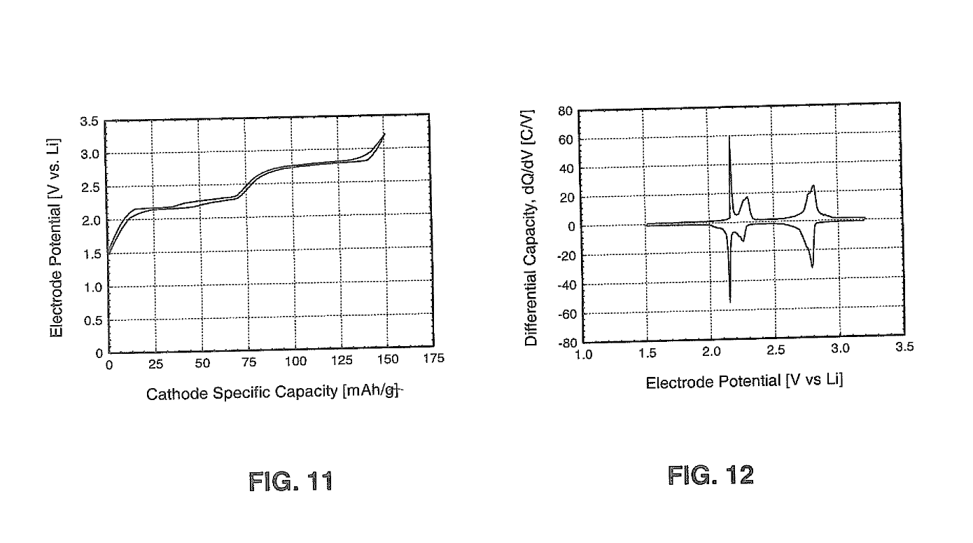

A third LiVPO₄F 11M LiPF₆ (EC/DMC)/Li₄Ti₅O₁₂ cell was constructed per the teachings of Example 5 (LiVPO₄F=11.2 mg, Li₄Ti₅O₁₂=10.1 mg). FIG. 7 shows the first cycle EVS results for the LiVPO₄F/1M LiPF₆ (EC/DMC)/Li₄Ti₅O₁₂ cell (voltage range: 2 V-3 V; critical current density <100 μA/cm²; voltage step=10 mV). The testing was carried out at ambient temperature (˜23° C.). The initial measured open circuit voltage (OCV) was approximately 3.10 V. The fluorophosphate cathode material exhibited a 148 mA·h/g lithium extraction capacity, and a 142 mA·h/g lithium insertion capacity capacity. The titanate anode material exhibited a 164 mA·h/g lithium insertion capacity, and a 158 mA·h/g lithium extraction capacity. The generally symmetrical nature of the charge-discharge curves further indicates the good reversibility of the system.

FIG. 8 is an EVS differential capacity plot based on FIG. 7. As can be seen from FIG. 8, the relatively symmetrical nature of the peaks indicates good electrical reversibility. There are small peak separations (charge/discharge), and good correspondence between peaks above and below the zero axis. There are essentially no peaks that can be related to irreversible reactions, since peaks above the axis (cell charge) have corresponding peaks below the axis (cell discharge), and there is very little separation between the peaks above and below the axis. This shows that the LiVPO₄F/Li₄Ti₅O₁₂ couple is a suitable for use in a cell.

### Example 6

An electrode active material of formula Li₄Ti₅O₁₂ was synthesized per the teachings of Example 1. A counter electrode active material of the formula Na₃V₂(PO₄)₂F₃ was made as follows. First, a VPO₄ precursor was made according to the following reaction scheme.

V₂O₅+2(NH₄)₂HPO₄+C→2VPO₄

A mixture of 18.2 g (0.1 mol) V₂O₅, 26.4 g (0.2 mol) (NH₄)₂HPO₄, and 2.4 g (0.2 mol) of elemental carbon was made, using a mortar and pestle. The mixture was pelletized, and transferred to a box oven equipped with an argon gas flow. The mixture was heated to a temperature of about 350° C., and maintained at this temperature for 3 hours. The mixture was then heated to a temperature of about 750° C., and maintained at this temperature for 8 hours. The product was then cooled to ambient temperature (about 21° C.).

Na₃V₂(PO₄)₂F₃ was then made from the VPO₄ precursor. The material was made according to the following reaction scheme.

2VPO₄+3NaF→Na₃V₂(PO₄)₂F₃

A mixture of 2.92 g of VPO₄ and 1.26 g of NaF was made, using a mortar and pestle. The mixture was pelletized, and transferred to a temperature-controlled tube furnace equipped with an argon gas flow. The mixture was heated at a ramp rate of about 2° C./minute to an ultimate temperature of about 750° C. for 1 hour. The product was then cooled to ambient temperature (about 20° C.).

A first electrode was made with ˜84% of the Li₄Ti₅O₁₂ active material (11.1 mg), 5% of Super P conductive carbon, and 11% PVdF-HFP co-polymer (Elf Atochem) binder. A second counter-electrode electrode was made with ˜84% of the Na₃V₂(PO₄)₂F₃ active material (11.9 mg), 5% of Super P conductive carbon, and 11% PVdF-HFP co-polymer (Elf Atochem) binder.

A cell was constructed using the first and second electrodes and an electrolyte comprising 1M LiPF₆ solution in ethylene carbonate/dimethyl carbonate (2:1 by weight), while a dried glass fiber filter (Whatman, Grade GF/A) was used as electrode separator.

FIGS. sets 9/10 and 11/12 show the voltage profile and differential capacity plots for the first and fifth cycle EVS responses, respectively, of the Na₃V₂(PO₄)₂F₃/1M LiPF₆ (EC/DMC)/Li₄Ti₅O₁₂ cell (voltage range: 1.5-3.2 V; Critical current density <100 μA/cm²; voltage step=10 mV). The testing was carried out at ambient temperature (˜23° C.). The initial measured open circuit voltage (OCV) was approximately 1.55V. The fluorophosphate cathode material exhibited a 160 mA·h/g lithium extraction capacity, and a 156 mA·h/g lithium insertion capacity for the first cycle. The first cycle results demonstrated a first cycle charge efficiency of >97%. The fluorophosphate cathode material exhibited a 150 mA·h/g lithium extraction capacity, and a 150 mA·h/g lithium insertion capacity for the fifth cycle.

The titanate anode material exhibited a 171 mA·h/g lithium insertion capacity, and a 167 mA·h/g lithium extraction capacity for the first cycle. The titanate anode material exhibited a 161 mA·h/g lithium insertion capacity, and a 161 mA·h/g lithium extraction capacity for the fifth cycle. The generally symmetrical nature of the charge-discharge curves further indicates the good reversibility of the system.

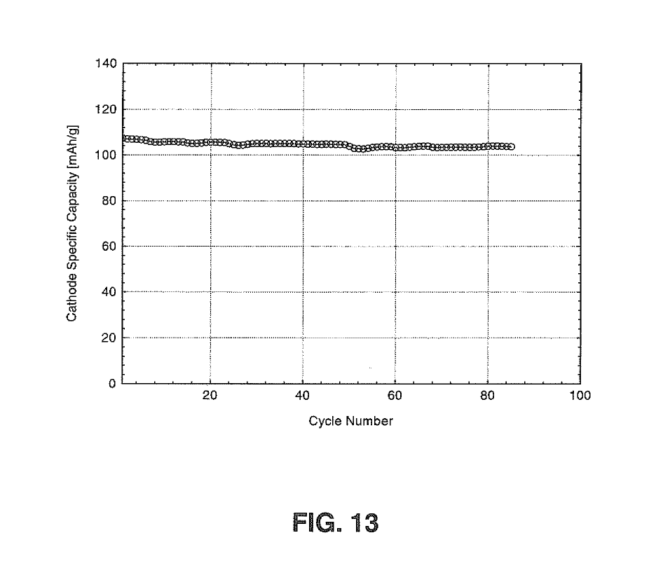

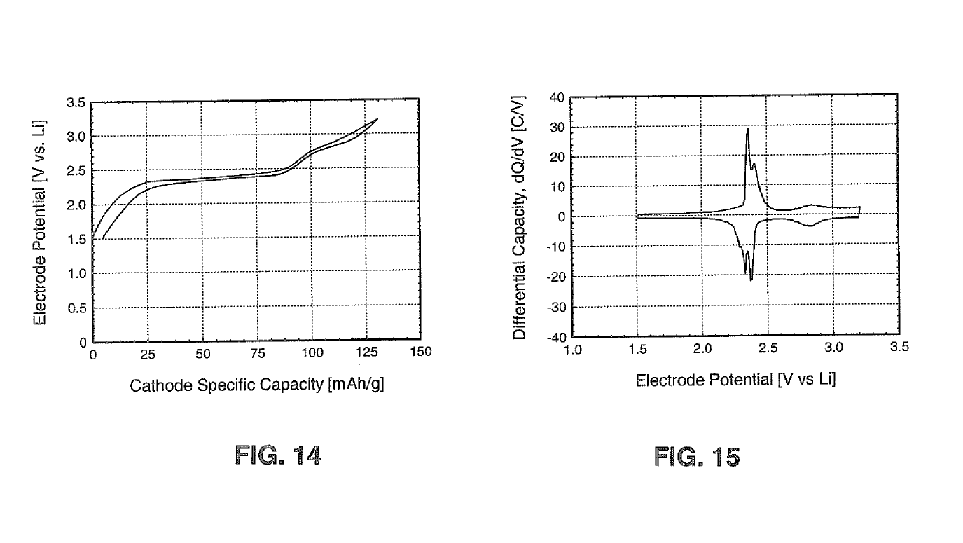

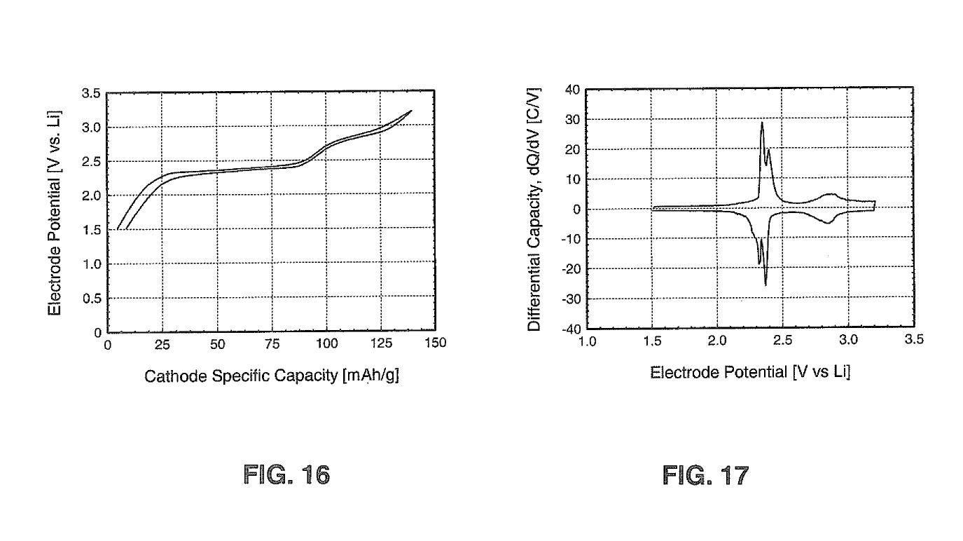

The EVS differential capacity plots for the first and fifth cycles, FIGS. 10 and 12, respectively, indicate good electrical reversibility. There are small peak separations (charge/discharge), and good correspondence between peaks above and below the zero axis. There are essentially no peaks that can be related to irreversible reactions, since peaks above the axis (cell charge) have corresponding peaks below the axis (cell discharge), and there is very little separation between the peaks above and below the axis. This shows that the Na₃V₂(PO₄)₂F₃/Li₄Ti₅O₁₂ couple is suitable for use in a cell.

FIG. 13 shows the cycling behavior of the Na₃V₂(PO₄)₂F₃/1M LiPF₆ (EC/DMC)/Li₄Ti₅O₁₂ cell. The data was collected at approximate charge/discharge rate of C/2. The initial cathode reversible capacity was approximately 110 mA·h/g and the cells cycle with relatively low capacity fade behavior. The minor decrease in discharge capacity is indicative of the excellent rate characteristics of this system.

A second cell was constructed per the teachings in this example, comprising a 2:1 Na:Li salt mixture using a mixture of 2M NaPF₆ and 1M LiPF₆ in ethylene carbonate/dimethyl carbonate (2:1 by weight) electrolyte (Na₃V₂(PO₄)₂F₃/1M LiPF₆+2M NaPF₆ (EC/DMC)/Li₄Ti₅O₁₂).

The first electrode was made with ˜84% of the Li₄Ti₅O₁₂ active material (11.3 mg), 5% of Super P conductive carbon, and 11% PVdF-HFP co-polymer (Elf Atochem) binder. The second counter-electrode electrode was made with ˜84% of the Na₃V₂(PO₄)₂F₃ active material (12.0 mg), 5% of Super P conductive carbon, and 11% PVdF-HFP co-polymer (Elf Atochem) binder.

FIGS. sets 14/15 and 16/17 show the voltage profile and differential capacity plots for the first and second cycle EVS responses, respectively, of the Na₃V₂(PO₄)₂F₃/1M LiPF₆+2M NaPF₆ (EC/DMC)/Li₄Ti₅O₁₂ cell (voltage range: 1.5-3.2 V; Critical current density <100 μA/cm²; voltage step=10 mV). The testing was carried out at ambient temperature (˜23° C.). The initial measured open circuit voltage (OCV) was approximately 1.55V. The fluorophosphate cathode material exhibited a 130 mA·h/g lithium extraction capacity, and a 120 mA·h/g lithium insertion capacity for the first cycle. The fluorophosphate cathode material exhibited a 131 mA·h/g lithium extraction capacity, and a 128 mA·h/g lithium insertion capacity for the second cycle.

The titanate anode material exhibited a 138 mA·h/g lithium insertion capacity, and a 128 mA·h/g lithium extraction capacity for the first cycle. The titanate anode material exhibited a 139 mA·h/g lithium insertion capacity, and a 136 mA·h/g lithium extraction capacity for the second cycle. The generally symmetrical nature of the charge-discharge curves further indicates the good reversibility of the system.

The EVS differential capacity plots for the first and second cycles, FIGS. 15 and 17, respectively, indicate good electrical reversibility. There are small peak separations (charge/discharge), and good correspondence between peaks above and below the zero axis. There are essentially no peaks that can be related to irreversible reactions, since peaks above the axis (cell charge) have corresponding peaks below the axis (cell discharge), and there is very little separation between the peaks above and below the axis. This shows that the Na₃V₂(PO₄)₂F₃/Li₄Ti₅O₁₂ couple is suitable for use in a cell having a 1M LiPF₆+2M NaPF₆ (EC/DMC) electrolyte.

### Example 7

Active material of formula L₃V₂(PO₄)₃ was made according to the following reaction scheme.

3LiH₂PO₄+V₂O₃+xC→L₃V₂(PO₄)₃+2CO₂

To make L₃V₂(PO₄)₃, 15 g LiH₂PO₄ (Aldrich), 7.25 g V₂O₃ (Stratcor) and 0.70 g of Super P carbon (Ensaco) are premixed, pelletized, placed in an oven and heated in a flowing argon atmosphere at 900° C. for 8 hours, after which the sample is cooled to room temperature and removed from the oven.

A first cell was constructed as follows. A first electrode was made with 83% by weight Li₄Ti₅O₁₂ active material (commercially available from Sud-Chemie under the trade name EXM 1037), 10% by weight Super P conductive carbon, and 7% by weight PVdF binder. A second counter-electrode electrode was made with 84.5% by weight L₃V₂(PO₄)₃ active material, 8.5% of Super P conductive carbon, and 7% PVdF binder. The first cell was constructed using the first and second electrodes and an electrolyte comprising 0.13M LiPF₆ solution in ethylene carbonate/dimethyl carbonate/ethyl-methyl carbonate (2:5:3 by weight), while a Celgard 2300 separator was used as electrode separator.

A second cell was constructed in the same manner as the first, except formulation for the first electrode was as follows: 87% by weight Li₄Ti₅O₁₂ active material (commercially available from Sud-Chemie under the trade name EXM 1037), 6% by weight Super P conductive carbon, and 7% by weight PVdF binder.

To test the electrochemical performance of the cells, the cells were initially cycled three times between 1.5V and 3.2V at C/5. Thereafter, for 20 C charge cycling, the charge voltage was maintained at 3.8V until the current dropped to 20% of its initial value. The testing was carried out at ambient temperature (˜23° C.).

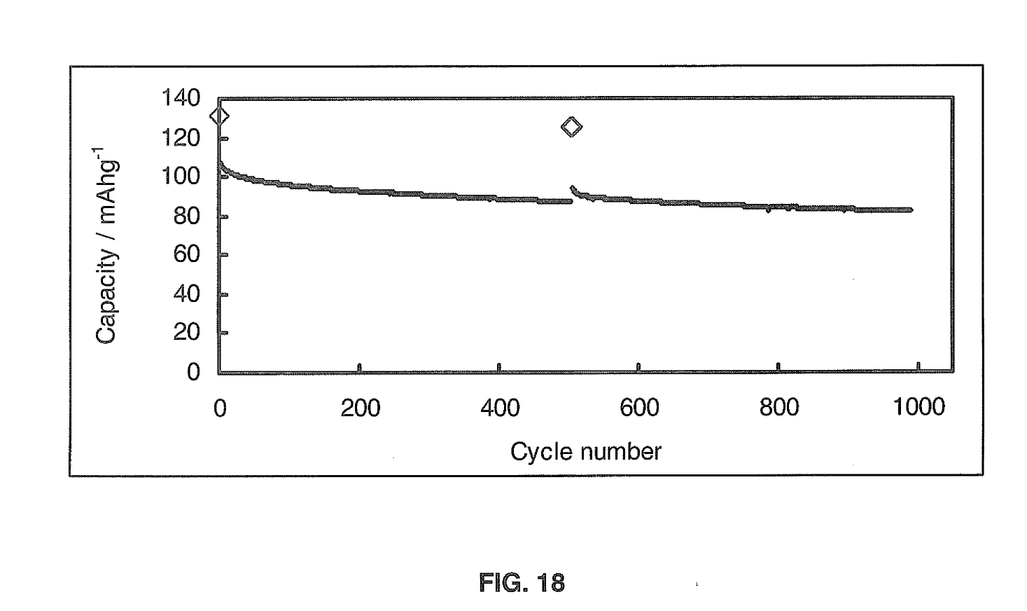

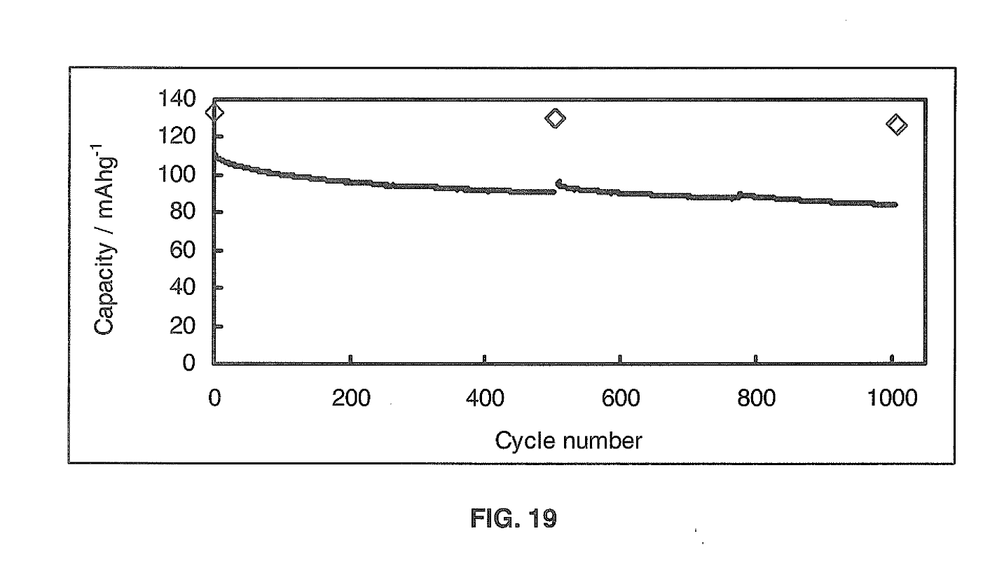

FIGS. 18 and 19 shows the cycling behavior of the first and second cells, respectively. The data was collected at a charge rate of 20 C (after the initial three conditioning cycles), and a discharge rate of C/2. The initial cathode reversible discharge capacity was 131 mA·h/g for the first cell and 133 mA·h/g for the second cell, and the capacity at the third cycle was 106 mA·h/g for the first cell and 110 mA·h/g for the second cell. After a 1,000 cycles, the first cell exhibited 77% of its initial capacity and the second cell exhibited 76% of its initial capacity. The amount of decrease in discharge capacity is indicative of the excellent high rate characteristics of this system.

In addition, both cells exhibited recoverable capacity. At approximately the 500^{th} cycle, each cell was returned to a C/2 charge rate for four consecutive cycles (referred to as “intermediate C/2 cycles” and indicated by reference symbol “⋄” in FIGS. 18 and 19). The first cell exhibited a discharge capacity of 87 mA·h/g immediately prior to the intermediate C/2 cycles, 125 mA·h/g for the intermediate C/2 cycles, and 95 mA·h/g immediately after the cell was returned to the 20 C charge rate. The second cell exhibited a capacity of 91 mA·h/g immediately prior to the intermediate C/2 cycles, 130 mA·h/g for the intermediate C/2 cycles, and 96 mA·h/g immediately after the cell was returned to the 20 C charge rate.

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

What is claimed is:

1. A battery, comprising:
a first electrode comprising a first electrode active material represented by the general formula:
AₐM_{b}L_{c}Z_{d},
wherein:
A. A is selected from the group consisting of elements from Group I of the Periodic Table, and mixtures thereof, and 0≦a≦9;
B. M includes at least one redox active element, and 0<b≦4;
C. L is selected from the group consisting of X′[O₄₋ₓ,Y′ₓ], X′[O_{4-y},Y′_{2y}], X″S₄, [X_{z}′″,X′_{1-z}]O₄, and mixtures thereof, wherein:
i) X′ and X′″ are each independently selected from the group consisting of P, As, Sb, Si, Ge, V, S, and mixtures thereof;
ii) X″ is selected from the group consisting of P, As, Sb, Si, Ge, V, and mixtures thereof;
iii) Y′ is selected from the group consisting of halogens selected from Group 17 of the Periodic Table, S, N, and mixtures thereof;
iv) 0≦x≦3, 0≦y≦2, 0≦z≦1 and 0<z≦3; and
v) Z is selected from the group consisting of a hydroxyl (OH), a halogen selected from Group 17 of the Periodic Table, and mixtures thereof, and 0≦e≦4; and
vi) wherein A, M, L, Z, a, b, c and d are selected so as to maintain electroneutrality of the first electrode active material in its nascent state;
a second counter-electrode comprising a counter-electrode active material represented by the general formula:
E_{f}Ti_{g}DₕOᵢ,
wherein:
(i) E is selected from the group consisting of elements from Group I of the Periodic Table, and mixtures thereof, and 0<f<12;
(ii) 0<g≦6;
(iii) D is selected from the group consisting of Al, Zr, Mg, Ca, Zn, Cd, Fe, Mn, Ni, Co, and mixtures thereof, and 0≦h≦2; and
(iv) 2≦i≦12; and
(v) wherein E, D, f, g, h and i are selected so as to maintain electroneutrality of the second counter-electrode active material in its nascent state; and
an electrolyte in ion-transfer communication with the first electrode and the second electrode.

2. A battery according to claim 1, wherein the electrolyte is a RTIL electrolyte selected from the group consisting of compounds represented by general formulas (A) through (K): 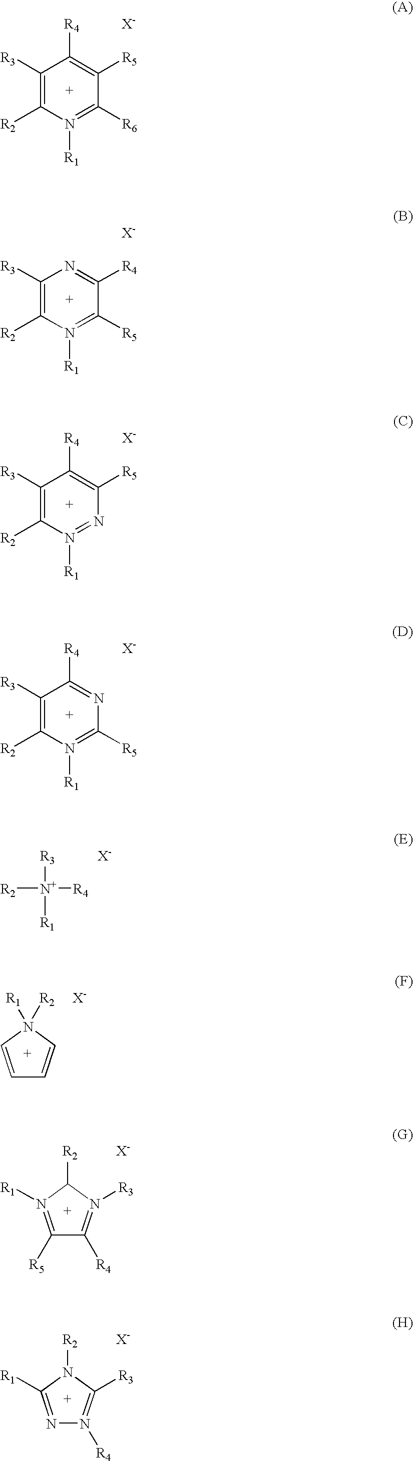 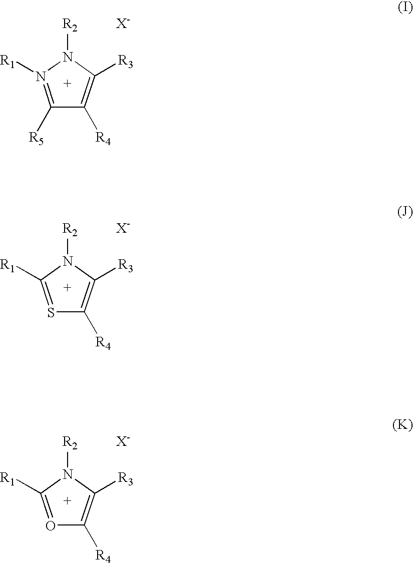
and mixtures thereof, wherein:
(1) R₁, R₂, R₃, R₄, R₅ and R₆ are each independently selected from the group consisting of: H; F; Cl; Br; and linear and branched alkyl, hydroxyalkyl, benzylalkyl, alkyl halide, oxoalkyl, alkoxyalkyl, aminoalkyl, carboxyalkyl, sulfonylalkyl, phosphoalkyl, and sulfoalkyl groups of 1 to 7 carbon atoms; and
(2) X⁻ is selected the group consisting of: Cl⁻; BF₄⁻; Br⁻; (CF₃)ₐPF_{b}⁻ (wherein a+b=6 and a and b are each greater or equal to 0 (a,b≧0)); compounds represented by general formulas (L) and (M): 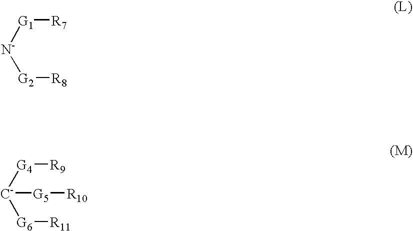
and mixtures thereof; wherein:
(1) G₁ and G₂, G₃, G₄, G₅, and G₆ are each independently selected from the group consisting of —CO— and SO₂—; and
(2) R₇, R₈, R₉, R₁₀, and R₁₁ are each independently selected from the group consisting of H, F, Cl, Br, halogenated alkyl groups of 1 to 5 carbon atoms, and alkyl nitrile groups of 1 to 5 carbon atoms.

3. The battery according either claim 2, wherein the first electrode active material is represented by the general formula:
AₐM_{b}PO₄Z_{d},
wherein 0.1<a≦4, 8≦b≦1.2 and 0≦d≦4; and wherein A, M, Z, a, b, and d are selected so as to maintain electroneutrality of the electrode active material in its nascent or as-synthesized state.

4. The battery according to claim 2, wherein the first electrode active material is represented by the general formula:
AM′₁₋ⱼM″ⱼPO₄,
wherein M′ is at least one transition metal from Groups 4 to 11 of the Periodic Table and has a +2 valence state; M″ is at least one metallic element which is from Group 2, 12, or 14 of the Periodic Table and has a +2 valence state; and 0<j<1.

5. The battery according to claim 2, wherein the first electrode active material is represented by the general formula:
LiFe₁₋ₖM″ₖPO₄,
wherein M″ is selected from the group consisting of Mg, Ca, Zn, Sr, Pb, Cd, Sn, Ba, Be, and mixtures thereof; and 0<k<1.

6. The battery according to claim 2, wherein the first electrode active material is represented by the general formula:
AₐCoᵤFeᵥM¹³_{w}M¹⁴ₐₐM¹⁵_{bb}L,
wherein:
(vi) composition variable A is as described herein above, 0<a≦2
(vii) u>0 and v>0;
(viii) M¹³ is one or more transition metals, wherein w≧0;
(ix) M¹⁴ is one or more +2 oxidation state non-transition metals, wherein aa≧0;
(x) M¹⁵ is one or more +3 oxidation state non-transition metals, wherein bb≧0;
(xi) L is selected from the group consisting of X′O₄₋ₓY′ₓ, X′O_{4-y}Y′_{2y}, X″S₄, and mixtures thereof, where X′ is selected from the group consisting of P, As, Sb, Si, Ge, V, S, and mixtures thereof; X″ is selected from the group consisting of P, As, Sb, Si, Ge, V and mixtures thereof; Y′ is selected from the group consisting of halogen, S, N, and mixtures thereof; 0≦x≦3; and 0<y≦2; and
wherein 0<(u+v+w+aa+bb)<2, and M¹³, M¹⁴, M¹⁵, L, a, u, v, w, aa, bb, x, and y are selected so as to maintain electroneutrality of the electrode active material in its nascent or as-synthesized state.

7. The battery according to claim 2, wherein the first electrode active material is represented by the general formula:
LiM(PO₄₋ₓY′ₓ),
wherein M is M¹⁶_{cc}M¹⁷_{dd}M¹⁸ₑₑM¹⁹_{ff}, and
(xii) M¹⁶ is one or more transition metals;
(xiii) M¹⁷ is one or more +2 oxidation state non-transition metals;
(xiv) M¹⁸ is one or more +3 oxidation state non-transition metals;
(xv) M¹⁹ is one or more +1 oxidation state non-transition metals;
(xvi) Y′ is halogen; and
wherein cc>0, each of dd, ee, and ff≧0, (cc+dd+ee+ff)≦1, and 0≦x≦0.2 and M¹⁶, M¹⁷, M¹⁸, M¹⁹, Y, cc, dd, ee, ff, and x are selected so as to maintain electroneutrality of the electrode active material in its nascent or as-synthesized state.

8. The battery according to claim 2, wherein the first electrode active material is represented by the general formula:
A¹ₐ(MO)_{gg}M′_{1-gg}XO₄,
wherein
(i) A¹ is independently selected from the group consisting of Li, Na, K and mixtures thereof, 0.1<a<2;
(ii) M comprises at least one element, having a +4 oxidation state, which is redox active; 0<gg≦1;
(iii) M′ is one or more metals selected from metals having a +2 and a +3 oxidation state; and
(iv) X is selected from the group consisting of P, As, Sb, Si, Ge, V, S, and mixtures thereof; and
wherein A¹, M, M′, X, a and gg are selected so as to maintain electroneutrality of the electrode active material in its nascent or as-synthesized state.

9. The battery according to claim 2, wherein the first electrode active material is represented by the general formula:
AₐM_{b}L₃Z_{d},
wherein 2≦a≦8, 1≦b≦3, and 0≦d≦6; and
wherein M, L, Z, a, b, d, x and y are selected so as to maintain electroneutrality of the electrode active material in its nascent or as-synthesized state.

10. The battery according to claim 2, wherein the second counter-electrode active material is selected from the group consisting of Li₄Ti₅O₁₂; Li₅Ti₄AlO₁₂; rutile and anatase forms of TiO₂, including magneli type phases having the general formula TiₙO₂ₙ₋₁(4≦n≦9); TiO; Ti₄O₅; Ti₃O₅; LiTiO₂; Ti₄O₇; Li₂Ti₃O₇; and LiTi₂O₄.

11. The battery according to claim 10, wherein the second counter-electrode active material is Li₄Ti₅O₁₂.

12. The battery according either claim 1, wherein the first electrode active material is represented by the general formula:
AₐM_{b}PO₄Z_{d},
wherein 0.1<a≦4, 8≦b≦1.2 and 0≦d≦4; and wherein A, M, Z, a, b, and d are selected so as to maintain electroneutrality of the electrode active material in its nascent or as-synthesized state.

13. The battery according to claim 1, wherein the first electrode active material is represented by the general formula:
AM′₁₋ⱼM″ⱼPO₄,
wherein M′ is at least one transition metal from Groups 4 to 11 of the Periodic Table and has a +2 valence state; M″ is at least one metallic element which is from Group 2, 12, or 14 of the Periodic Table and has a +2 valence state; and 0<j<1.

14. The battery according to claim 1, wherein the first electrode active material is represented by the general formula:
LiFe₁₋ₖM″ₖPO₄,
wherein M″ is selected from the group consisting of Mg, Ca, Zn, Sr, Pb, Cd, Sn, Ba, Be, and mixtures thereof; and 0<k<1.

15. The battery according to claim 1, wherein the first electrode active material is represented by the general formula:
AₐCoᵤFeᵥM¹³_{w}M¹⁴ₐₐM¹⁵_{bb}L,
wherein:
(xvii) composition variable A is as described herein above, 0<a≦2
(xviii) u>0 and v>0;
(xix) M¹³ is one or more transition metals, wherein w≧0;
(xx) M¹⁴ is one or more +2 oxidation state non-transition metals, wherein aa≧0;
(xxi) M¹⁵ is one or more +3 oxidation state non-transition metals, wherein bb≧0;
(xxii) L is selected from the group consisting of X′O₄₋ₓY′ₓ, X′O_{4-y}Y′_{2y}, X″S₄, and mixtures thereof, where X′ is selected from the group consisting of P, As, Sb, Si, Ge, V, S, and mixtures thereof; X″ is selected from the group consisting of P, As, Sb, Si, Ge, V and mixtures thereof; Y′ is selected from the group consisting of halogen, S, N, and mixtures thereof; 0≦x≦3; and 0<y≦2; and
wherein 0<(u+v+w+aa+bb)<2, and M¹³, M¹⁴, M¹⁵, L, a, u, v, w, aa, bb, x, and y are selected so as to maintain electroneutrality of the electrode active material in its nascent or as-synthesized state.

16. The battery according to claim 1, wherein the first electrode active material is represented by the general formula:
LiM(PO₄₋ₓY′ₓ),
wherein M is M¹⁶_{cc}M¹⁷_{dd}M¹⁸ₑₑM¹⁹_{ff}, and
(xxiii) M¹⁶ is one or more transition metals;
(xxiv) M¹⁷ is one or more +2 oxidation state non-transition metals;
(xxv) M¹⁸ is one or more +3 oxidation state non-transition metals;
(xxvi) M¹⁹ is one or more +1 oxidation state non-transition metals;
(xxvii) Y′ is halogen; and
wherein cc>0, each of dd, ee, and ff≧0, (cc+dd+ee+ff)≦1, and 0≦x≦0.2 and M¹⁶, M¹⁷, M¹⁸, M¹⁹, Y, cc, dd, ee, if, and x are selected so as to maintain electroneutrality of the electrode active material in its nascent or as-synthesized state.

17. The battery according to claim 1, wherein the first electrode active material is represented by the general formula:
A¹ₐ(MO)_{gg}M′_{1-gg}XO₄,
wherein
(i) A¹ is independently selected from the group consisting of Li, Na, K and mixtures thereof, 0.1<a<2;
(ii) M comprises at least one element, having a +4 oxidation state, which is redox active; 0<gg≦1;
(iii) M′ is one or more metals selected from metals having a +2 and a +3 oxidation state; and
(iv) X is selected from the group consisting of P, As, Sb, Si, Ge, V, S, and mixtures thereof; and
wherein A¹, M, M′, X, a and gg are selected so as to maintain electroneutrality of the electrode active material in its nascent or as-synthesized state.

18. The battery according to claim 1, wherein the first electrode active material is represented by the general formula:
AₐM_{b}L₃Z_{d},
wherein 2≦a≦8, 1≦b≦3, and 0≦d≦6; and
wherein M, L, Z, a, b, d, x and y are selected so as to maintain electroneutrality of the electrode active material in its nascent or as-synthesized state.

19. The battery according to claim 1, wherein the second counter-electrode active material is selected from the group consisting of Li₄Ti₅O₁₂; Li₅Ti₄AlO₁₂; rutile and anatase forms of TiO₂, including magneli type phases having the general formula TiₙO₂ₙ₋₁(4≦n≦9); TiO; Ti₄O₅; Ti₃O₅; LiTiO₂; Ti₄O₇; Li₂Ti₃O₇; and LiTi₂O₄.

20. The battery according to claim 19, wherein the second counter-electrode active material is Li₄Ti₅O₁₂.
